(19) United States
(12) Patent Application Publication
(10) Pub. No.: US 2026/0079569 A1
(43) Pub. Date: Mar. 19, 2026

(54) TEMPORAL CONTEXT FROM EYE TRACKING FOR GENERATIVE AI

(71) Applicant: Snap Inc., Santa Monica, CA (US)

(72) Inventors: Georgios Evangelidis, Vienna (AT); Candace Elise Peacock, Boulder, CO (US); Weston Welge, Boulder, CO (US)

(21) Appl. No.: 18/943,262

(22) Filed: Nov. 11, 2024

(30) Foreign Application Priority Data
Sep. 16, 2024 (GR) 20240100632

(51) Int. Cl. G06F 3/01; G02B 27/01

(52) U.S. Cl. CPC G06F 3/013; G02B 27/017

(57) ABSTRACT

Examples relate to systems and methods for enhancing generative AI outputs using eye tracking data. An eye tracking system accesses eye gaze information associated with a field of view of a head-wearable apparatus and generates contextual information associated with the field of view of the head-wearable apparatus based on the eye gaze information. The eye tracking system processes, by a generative machine learning model, the contextual information and at least one image of the field of view of the head-wearable apparatus to generate an output and presents on a display of the head-wearable apparatus the output generated by the generative machine learning model.

### CLAIM OF PRIORITY

This application claims the benefit of priority to Greece Patent Application Serial No. 20240100632, filed Sep. 16, 2024, which is incorporated herein by reference in its entirety.

### TECHNICAL FIELD

The present disclosures relate to generative artificial intelligence and, in some examples, to algorithms and systems to enhance AI outputs using eye tracking data for contextual inference.

### BACKGROUND

Some electronics-enabled eyewear devices, such as so-called smart glasses, allow users to interact with virtual content (e.g., augmented reality (AR) objects) while a user is engaged in an activity. Users wear the eyewear devices and can view a real-world environment through the eyewear devices while interacting with the virtual content that is displayed by the eyewear devices. Certain electronics-enabled eyewear devices (and other AR devices) allow users to interact with the virtual content (or real-world content) based on tracking eye gaze of the user (e.g., tracking/determining where the user is looking in the environment presented to the user).

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1 is a diagrammatic representation of a networked environment in which the present disclosure may be deployed, according to some examples.

FIG. 2 is a diagrammatic representation of a digital interaction system that has both client-side and server-side functionality, according to some examples.

FIG. 3 is a diagrammatic representation of a data structure as maintained in a database, according to some examples.

FIG. 4 is a diagrammatic representation of a message, according to some examples.

FIG. 5 illustrates a diagram of an eye tracking system, according to some examples.

FIGS. 6 and 7 illustrate routines performed by the eye tracking system, in accordance with some examples.

FIG. 8 illustrates a diagram of a field of view processed by the eye tracking system, in accordance with some examples.

FIG. 9 illustrates a system including the head-wearable apparatus, according to some examples.

FIG. 10 is a diagrammatic representation of a machine in the form of a computer system within which a set of instructions may be executed to cause the machine to perform any one or more of the methodologies discussed herein, according to some examples.

FIG. 11 is a block diagram showing a software architecture within which examples may be implemented.

### DETAILED DESCRIPTION

The description that follows discusses illustrative examples of the disclosure. In the following description, for the purposes of explanation, numerous specific details are set forth to provide an understanding of various examples of the disclosed subject matter. It will be evident, however, to those skilled in the art, that examples of the disclosed subject matter may be practiced without these specific details. In general, well-known instruction instances, protocols, structures, and techniques are not necessarily shown in detail.

Typical smart glasses platforms allow users to interact with various types of virtual content. Such platforms are configured to display the virtual content in the lenses of the smart glasses over a real-world environment seen through the lenses of the smart glasses. To interact with the virtual content, the smart glasses can include an embedded sensor (e.g., a camera or video sensor) that tracks eye movements and pupil diameters. Based on where the user is gazing, the smart glasses can control the virtual content that is overlaid on the display or other content that is presented to the user. This allows the user to interact with the content just by looking in a certain direction (or focusing their attention on virtual content).

Generative artificial intelligence has emerged as a powerful technology for producing human-like outputs across various domains, including text, images, and audio. As these systems become more sophisticated, they face challenges in accurately interpreting user intent and providing contextually relevant responses. Traditional input methods, such as text or voice commands, often lack the nuanced information needed to fully understand a user's cognitive state and environmental context. Conventional systems have many disparate components that independently collect valuable information but fail to process the information in a cohesive manner. This results in information provided to users that may not be very relevant. As a result, the users may need to provide multiple queries to achieve a desired result which wastes time, system resources, and power.

Eye tracking technology has been extensively studied in fields like cognitive psychology and human-computer interaction. Research has shown that eye movements can provide valuable insights into an individual's attention, cognitive processes, and emotional states. However, integrating this rich source of information with generative AI systems presents technical hurdles in data collection, analysis, and real-time processing. The development of augmented reality (AR) devices has opened up new possibilities for seamlessly capturing and utilizing eye tracking data in everyday scenarios. These devices face the challenge of balancing computational requirements with user comfort and privacy concerns.

The disclosed examples improve the efficiency of using the electronic device by providing an AR device (e.g., an eyewear device) that allows users to interact with virtual content or AR objects displayed by the AR device and receive related information in a seamless manner based on a gaze direction of the user's eyes. In some cases, the disclosed techniques access eye gaze information associated with a field of view of a head-wearable apparatus and generate contextual information associated with the field of view of the head-wearable apparatus based on the eye gaze information. The disclosed techniques process, by a generative machine learning model (e.g., a generative AI and/or large language model (LLM)), the contextual information and at least one image of the field of view of the head-wearable apparatus to generate an output and present the output generated by the generative machine learning model on a display of the head-wearable apparatus. While the disclosed techniques refer to an eye tracking system, similar techniques can be implemented by any component of a user device or head-wearable apparatus or combination of such devices.

In this way, the disclosed examples increase the efficiencies of the electronic device by reducing the amount of information and inputs needed to accomplish a task and reducing running complex image processing algorithms on the AR device. The disclosed examples further increase the efficiency, appeal, and utility of electronic AR devices, such as eyewear devices. While the disclosed examples are provided within a context of electronic eyewear devices, similar examples can be applied to any other type of AR wearable device, such as an AR hat, an AR watch, an AR belt, an AR ring, an AR bracelet, AR earrings, and/or an AR headset or other device that allows users to control or interact with content based on eye tracking or eye gaze direction, such as using an eye gaze vector.

### Networked Computing Environment

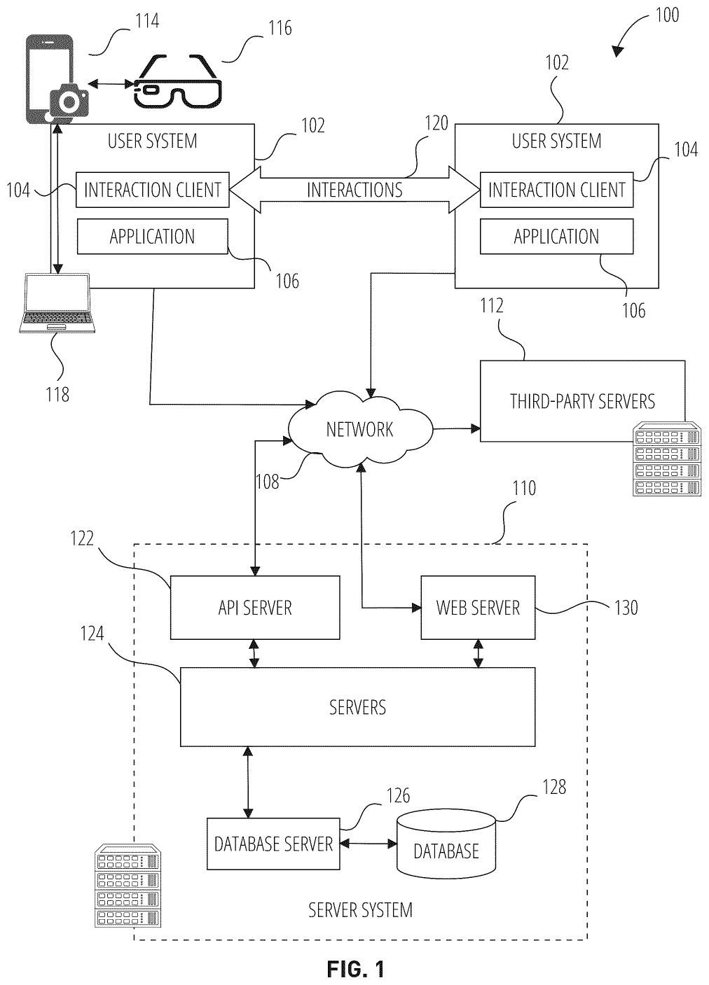

FIG. 1 is a block diagram showing an example digital interaction system 100 for facilitating interactions and engagements (e.g., exchanging text messages, conducting text audio and video calls, or playing games) over a network. The digital interaction system 100 includes multiple user systems 102 and/or head-wearable apparatus 116, each of which hosts multiple applications, including an interaction client 104 and other applications 106. Each interaction client 104 is communicatively coupled, via one or more networks including a network 108 (e.g., the Internet), to other instances of the interaction client 104 (e.g., hosted on respective other user systems 102), a server system 110 and third-party servers 112). An interaction client 104 can also communicate with locally hosted applications 106 using Applications Programming Interfaces (APIs).

Each user system 102 may include multiple user devices, such as a mobile device 114, head-wearable apparatus 116, and a computer client device 118 that are communicatively connected to exchange data and messages.

An interaction client 104 interacts with other interaction clients 104 and with the server system 110 via the network 108. The data exchanged between the interaction clients 104 (e.g., interactions 120) and between the interaction clients 104 and the server system 110 includes functions (e.g., commands to invoke functions) and payload data (e.g., text, audio, video, or other multimedia data).

The server system 110 provides server-side functionality via the network 108 to the interaction clients 104. While certain functions of the digital interaction system 100 are described herein as being performed by either an interaction client 104 or by the server system 110, the location of certain functionality either within the interaction client 104 or the server system 110 may be a design choice. For example, it may be technically preferable to initially deploy particular technology and functionality within the server system 110 but to later migrate this technology and functionality to the interaction client 104 where a user system 102 has sufficient processing capacity.

The server system 110 supports various services and operations that are provided to the interaction clients 104. Such operations include transmitting data to, receiving data from, and processing data generated by the interaction clients 104. This data may include message content, client device information, geolocation information, digital effects (e.g., media augmentation and overlays), message content persistence conditions, entity relationship information, and live event information. Data exchanges within the digital interaction system 100 are invoked and controlled through functions available via user interfaces (UIs) of the interaction clients 104.

Turning now specifically to the server system 110, an Application Program Interface (API) server 122 is coupled to and provides programmatic interfaces to servers 124, making the functions of the servers 124 accessible to interaction clients 104, other applications 106 and third-party server 112. The servers 124 are communicatively coupled to a database server 126, facilitating access to a database 128 that stores data associated with interactions processed by the servers 124. Similarly, a web server 130 is coupled to the servers 124 and provides web-based interfaces to the servers 124. To this end, the web server 130 processes incoming network requests over the Hypertext Transfer Protocol (HTTP) and several other related protocols.

The Application Program Interface (API) server 122 receives and transmits interaction data (e.g., commands and message payloads) between the servers 124 and the user systems 102 (and, for example, interaction clients 104 and other application 106) and the third-party server 112. Specifically, the Application Program Interface (API) server 122 provides a set of interfaces (e.g., routines and protocols) that can be called or queried by the interaction client 104 and other applications 106 to invoke functionality of the servers 124. The Application Program Interface (API) server 122 exposes various functions supported by the servers 124, including account registration; login functionality; the sending of interaction data, via the servers 124, from a particular interaction client 104 to another interaction client 104; the communication of media files (e.g., images or video) from an interaction client 104 to the servers 124; the settings of a collection of media data (e.g., a narrative); the retrieval of a list of friends of a user of a user system 102; the retrieval of messages and content; the addition and deletion of entities (e.g., friends) to an entity relationship graph (e.g., the entity graph 308); the location of friends within an entity relationship graph; and opening an application event (e.g., relating to the interaction client 104).

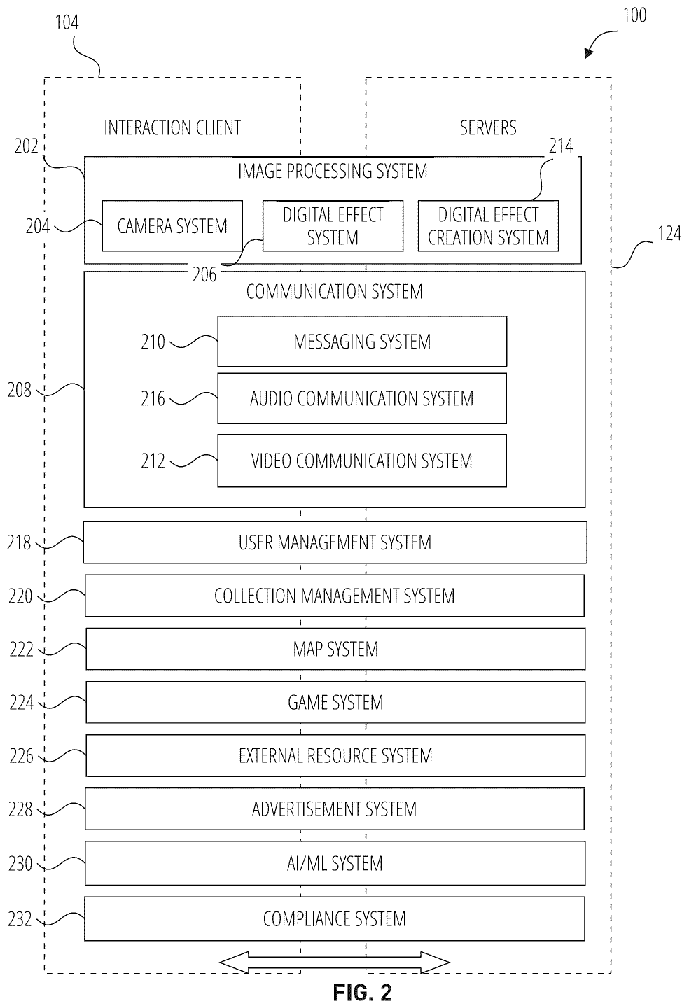

The servers 124 host multiple systems and subsystems, described below with reference to FIG. 2.

### External Resources and Linked Applications

The interaction client 104 provides a user interface that allows users to access features and functions of an external resource, such as a linked application 106, an applet, or a microservice. This external resource may be provided by a third party or by the creator of the interaction client 104.

The external resource may be a full-scale application installed on the user's system 102, or a smaller, lightweight version of the application, such as an applet or a microservice, hosted either on the user's system or remotely, such as on third-party servers 112 or in the cloud. These smaller versions, which include a subset of the full application's features, may be implemented using a markup-language document and may also incorporate a scripting language and a style sheet.

When a user selects an option to launch or access the external resource, the interaction client 104 determines whether the resource is web-based or a locally installed application. Locally installed applications can be launched independently of the interaction client 104, while applets and microservices can be launched or accessed via the interaction client 104.

If the external resource is a locally installed application, the interaction client 104 instructs the user's system to launch the resource by executing locally stored code. If the resource is web-based, the interaction client 104 communicates with third-party servers to obtain a markup-language document corresponding to the selected resource, which it then processes to present the resource within its user interface.

The interaction client 104 can also notify users of activity in one or more external resources. For instance, it can provide notifications relating to the use of an external resource by one or more members of a user group. Users can be invited to join an active external resource or to launch a recently used but currently inactive resource.

The interaction client 104 can present a list of available external resources to a user, allowing them to launch or access a given resource. This list can be presented in a context-sensitive menu, with icons representing different applications, applets, or microservices varying based on how the menu is launched by the user.

In some cases, the disclosed eye tracking system 504 can control content generated by and/or presented by the external resources, such as based on an eye gaze direction or vector of a user of the head-wearable apparatus 116.

### System Architecture

FIG. 2 is a block diagram illustrating further details regarding the digital interaction system 100, according to some examples. Specifically, the digital interaction system 100 is shown to comprise the interaction client 104 and the servers 124. The digital interaction system embodies multiple subsystems, which are supported on the client-side by the interaction client 104 and on the server-side by the servers 124. In some examples, these subsystems are implemented as microservices. A microservice subsystem (e.g., a microservice application) may have components that enable it to operate independently and communicate with other services. Example components of microservice subsystem may include:
Function logic: The function logic implements the functionality of the microservice subsystem, representing a specific capability or function that the microservice provides.
API interface: Microservices may communicate with each other components through well-defined APIs or interfaces, using lightweight protocols such as REST or messaging. The API interface defines the inputs and outputs of the microservice subsystem and how it interacts with other microservice subsystems of the digital interaction system 100.
Data storage: A microservice subsystem may be responsible for its own data storage, which may be in the form of a database, cache, or other storage mechanism (e.g., using the database server 126 and database 128). This enables a microservice subsystem to operate independently of other microservices of the digital interaction system 100.
Service discovery: Microservice subsystems may find and communicate with other microservice subsystems of the digital interaction system 100. Service discovery mechanisms enable microservice subsystems to locate and communicate with other microservice subsystems in a scalable and efficient way.
Monitoring and logging: Microservice subsystems may need to be monitored and logged to ensure availability and performance. Monitoring and logging mechanisms enable the tracking of health and performance of a microservice subsystem.

In some examples, the digital interaction system 100 may employ a monolithic architecture, a service-oriented architecture (SOA), a function-as-a-service (FaaS) architecture, or a modular architecture.

Example subsystems are discussed below.

An image processing system 202 provides various functions that enable a user to capture and modify (e.g., augment, annotate or otherwise edit) media content associated with a message. In some cases, the image processing system 202 includes an eye tracking system 504 (discussed below). The eye tracking system 504 can access eye gaze information associated with a field of view of a head-wearable apparatus 116 and generate contextual information associated with the field of view of the head-wearable apparatus 116 based on the eye gaze information. The eye tracking system 504 processes, by a generative machine learning model (e.g., the artificial intelligence and machine learning system 230), the contextual information and at least one image of the field of view of the head-wearable apparatus 116 to generate an output and presents on a display of the head-wearable apparatus 116 the output generated by the generative machine learning model.

A camera system 204 includes control software (e.g., in a camera application) that interacts with and controls camera hardware (e.g., directly or via operating system controls) of the user system 102 to modify real-time images captured and displayed via the interaction client 104.

A digital effect system 206 provides functions related to the generation and publishing of digital effects (e.g., media overlays) for images captured in real-time by cameras of the user system 102 or retrieved from memory of the user system 102. For example, the digital effect system 206 operatively selects, presents, and displays digital effects (e.g., media overlays such as image filters or modifications) to the interaction client 104 for the modification of real-time images received via the camera system 204 or stored images retrieved from a memory of a user system 102. These digital effects are selected by the digital effect system 206 and presented to a user of an interaction client 104, based on a number of inputs and data, such as for example:
Geolocation of the user system 102; and
Entity relationship information of the user of the user system 102.

Digital effects may include audio and visual content and visual effects. Examples of audio and visual content include pictures, texts, logos, animations, and sound effects. Examples of visual effects include color overlays and media overlays. The audio and visual content or the visual effects can be applied to a media content item (e.g., a photo or video) at user system 102 for communication in a message, or applied to video content, such as a video content stream or feed transmitted from an interaction client 104. As such, the image processing system 202 may interact with, and support, the various subsystems of the communication system 208, such as the messaging system 210 and the video communication system 212.

A media overlay may include text or image data that can be overlaid on top of a photograph taken by the user system 102 or a video stream produced by the user system 102. In some examples, the media overlay may be a location overlay (e.g., Venice beach), a name of a live event, or a name of a merchant overlay (e.g., Beach Coffee House). In further examples, the image processing system 202 uses the geolocation of the user system 102 to identify a media overlay that includes the name of a merchant at the geolocation of the user system 102. The media overlay may include other indicia associated with the merchant. The media overlays may be stored in the databases 128 and accessed through the database server 126.

The image processing system 202 provides a user-based publication platform that enables users to select a geolocation on a map and upload content associated with the selected geolocation. The user may also specify circumstances under which a particular media overlay should be offered to other users. The image processing system 202 generates a media overlay that includes the uploaded content and associates the uploaded content with the selected geolocation.

The digital effect creation system 214 supports augmented reality developer platforms and includes an application for content creators (e.g., artists and developers) to create and publish digital effects (e.g., augmented reality experiences) of the interaction client 104. The digital effect creation system 214 provides a library of built-in features and tools to content creators including, for example custom shaders, tracking technology, and templates.

In some examples, the digital effect creation system 214 provides a merchant-based publication platform that enables merchants to select a particular digital effect associated with a geolocation via a bidding process. For example, the digital effect creation system 214 associates a media overlay of the highest bidding merchant with a corresponding geolocation for a predefined amount of time.

A communication system 208 is responsible for enabling and processing multiple forms of communication and interaction within the digital interaction system 100 and includes a messaging system 210, an audio communication system 216, and a video communication system 212. The messaging system 210 is responsible, in some examples, for enforcing the temporary or time-limited access to content by the interaction clients 104. The messaging system 210 incorporates multiple timers that, based on duration and display parameters associated with a message or collection of messages (e.g., a narrative), selectively enable access (e.g., for presentation and display) to messages and associated content via the interaction client 104. The audio communication system 216 enables and supports audio communications (e.g., real-time audio chat) between multiple interaction clients 104. Similarly, the video communication system 212 enables and supports video communications (e.g., real-time video chat) between multiple interaction clients 104.

A user management system 218 is operationally responsible for the management of user data and profiles, and maintains entity information (e.g., stored in entity tables 306, entity graphs 308 and profile data 302) regarding users and relationships between users of the digital interaction system 100.

A collection management system 220 is operationally responsible for managing sets or collections of media (e.g., collections of text, image video, and audio data). A collection of content (e.g., messages, including images, video, text, and audio) may be organized into an “event gallery” or an “event collection.” Such a collection may be made available for a specified time period, such as the duration of an event to which the content relates. For example, content relating to a music concert may be made available as a “concert collection” for the duration of that music concert. The collection management system 220 may also be responsible for publishing an icon that provides notification of a particular collection to the user interface of the interaction client 104. The collection management system 220 includes a curation function that allows a collection manager to manage and curate a particular collection of content. For example, the curation interface enables an event organizer to curate a collection of content relating to a specific event (e.g., delete inappropriate content or redundant messages). Additionally, the collection management system 220 employs machine vision (or image recognition technology) and content rules to curate a content collection automatically. In certain examples, compensation may be paid to a user to include user-generated content into a collection. In such cases, the collection management system 220 operates to automatically make payments to such users to use their content.

A map system 222 provides various geographic location (e.g., geolocation) functions and supports the presentation of map-based media content and messages by the interaction client 104. For example, the map system 222 enables the display of user icons or avatars (e.g., stored in profile data 302) on a map to indicate a current or past location of “friends” of a user, as well as media content (e.g., collections of messages including photographs and videos) generated by such friends, within the context of a map. For example, a message posted by a user to the digital interaction system 100 from a specific geographic location may be displayed within the context of a map at that particular location to “friends” of a specific user on a map interface of the interaction client 104. A user can furthermore share his or her location and status information (e.g., using an appropriate status avatar) with other users of the digital interaction system 100 via the interaction client 104, with this location and status information being similarly displayed within the context of a map interface of the interaction client 104 to selected users.

A game system 224 provides various gaming functions within the context of the interaction client 104. The interaction client 104 provides a game interface providing a list of available games that can be launched by a user within the context of the interaction client 104 and played with other users of the digital interaction system 100. The digital interaction system 100 further enables a particular user to invite other users to participate in the play of a specific game by issuing invitations to such other users from the interaction client 104. The interaction client 104 also supports audio, video, and text messaging (e.g., chats) within the context of gameplay, provides a leaderboard for the games, and supports the provision of in-game rewards (e.g., coins and items).

An external resource system 226 provides an interface for the interaction client 104 to communicate with remote servers (e.g., third-party servers 112) to launch or access external resources, i.e., applications or applets. Each third-party server 112 hosts, for example, a markup language (e.g., HTML5) based application or a small-scale version of an application (e.g., game, utility, payment, or ride-sharing application)). The interaction client 104 may launch a web-based resource (e.g., application) by accessing the HTML5 file from the third-party servers 112 associated with the web-based resource. Applications hosted by third-party servers 112 are programmed in JavaScript leveraging a Software Development Kit (SDK) provided by the servers 124. The SDK includes Application Programming Interfaces (APIs) with functions that can be called or invoked by the web-based application. The servers 124 host a JavaScript library that provides a given external resource access to specific user data of the interaction client 104. HTML5 is an example of technology for programming games, but applications and resources programmed based on other technologies can be used.

To integrate the functions of the SDK into the web-based resource, the SDK is downloaded by the third-party server 112 from the servers 124 or is otherwise received by the third-party server 112. Once downloaded or received, the SDK is included as part of the application code of a web-based external resource. The code of the web-based resource can then call or invoke certain functions of the SDK to integrate features of the interaction client 104 into the web-based resource.

The SDK stored on the server system 110 effectively provides the bridge between an external resource (e.g., applications 106 or applets) and the interaction client 104. This gives the user a seamless experience of communicating with other users on the interaction client 104 while also preserving the look and feel of the interaction client 104. To bridge communications between an external resource and an interaction client 104, the SDK facilitates communication between third-party servers 112 and the interaction client 104. A bridge script running on a user system 102 establishes two one-way communication channels between an external resource and the interaction client 104. Messages are sent between the external resource and the interaction client 104 via these communication channels asynchronously. Each SDK function invocation is sent as a message and callback. Each SDK function is implemented by constructing a unique callback identifier and sending a message with that callback identifier.

By using the SDK, not all information from the interaction client 104 is shared with third-party servers 112. The SDK limits which information is shared based on the needs of the external resource. Each third-party server 112 provides an HTML5 file corresponding to the web-based external resource to servers 124. The servers 124 can add a visual representation (such as a box art or other graphic) of the web-based external resource in the interaction client 104. Once the user selects the visual representation or instructs the interaction client 104 through a GUI of the interaction client 104 to access features of the web-based external resource, the interaction client 104 obtains the HTML5 file and instantiates the resources to access the features of the web-based external resource.

The interaction client 104 presents a graphical user interface (e.g., a landing page or title screen) for an external resource. During, before, or after presenting the landing page or title screen, the interaction client 104 determines whether the launched external resource has been previously authorized to access user data of the interaction client 104. In response to determining that the launched external resource has been previously authorized to access user data of the interaction client 104, the interaction client 104 presents another graphical user interface of the external resource that includes functions and features of the external resource. In response to determining that the launched external resource has not been previously authorized to access user data of the interaction client 104, after a threshold period of time (e.g., 3 seconds) of displaying the landing page or title screen of the external resource, the interaction client 104 slides up (e.g., animates a menu as surfacing from a bottom of the screen to a middle or other portion of the screen) a menu for authorizing the external resource to access the user data. The menu identifies the type of user data that the external resource will be authorized to use. In response to receiving a user selection of an accept option, the interaction client 104 adds the external resource to a list of authorized external resources and allows the external resource to access user data from the interaction client 104. The external resource is authorized by the interaction client 104 to access the user data under an OAuth 2 framework.

The interaction client 104 controls the type of user data that is shared with external resources based on the type of external resource being authorized. For example, external resources that include full-scale applications (e.g., an application 106) are provided with access to a first type of user data (e.g., two-dimensional avatars of users with or without different avatar characteristics). As another example, external resources that include small-scale versions of applications (e.g., web-based versions of applications) are provided with access to a second type of user data (e.g., payment information, two-dimensional avatars of users, three-dimensional avatars of users, and avatars with various avatar characteristics). Avatar characteristics include different ways to customize a look and feel of an avatar, such as different poses, facial features, clothing, and so forth.

An advertisement system 228 operationally enables the purchasing of advertisements by third parties for presentation to end-users via the interaction clients 104 and handles the delivery and presentation of these advertisements.

An artificial intelligence and machine learning system 230 provides a variety of services to different subsystems within the digital interaction system 100. For example, the artificial intelligence and machine learning system 230 operates with the image processing system 202 and the camera system 204 to analyze images and extract information such as objects, text, or faces. This information can then be used by the image processing system 202 to enhance, filter, or manipulate images. The artificial intelligence and machine learning system 230 may be used by the digital effect system 206 to generate modified content and augmented reality experiences, such as adding virtual objects or animations to real-world images. The communication system 208 and messaging system 210 may use the artificial intelligence and machine learning system 230 to analyze communication patterns and provide insights into how users interact with each other and provide intelligent message classification and tagging, such as categorizing messages based on sentiment or topic. The artificial intelligence and machine learning system 230 may also provide chatbot functionality to message interactions 120 between user systems 102 and between a user system 102 and the server system 110. The artificial intelligence and machine learning system 230 may also work with the audio communication system 216 to provide speech recognition and natural language processing capabilities, allowing users to interact with the digital interaction system 100 using voice commands.

Machine learning is a field of study that gives computers the ability to learn without being explicitly programmed. The artificial intelligence and machine learning system 230 can be built using machine learning models. Machine learning (e.g., machine learning models) explores the study and construction of algorithms, also referred to herein as tools, that may learn from existing data and make predictions about new data. Such machine-learning tools operate by building a model from example training data in order to make data-driven predictions or decisions expressed as outputs or assessments. Although examples are presented with respect to a few machine-learning tools, the principles presented herein may be applied to other machine-learning tools.

In some examples, different machine-learning tools may be used. For example, Logistic Regression (LR), Naive-Bayes, Random Forest (RF), neural networks (NN), matrix factorization, and Support Vector Machines (SVM) tools may be used for classifying or scoring job postings.

Two common types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number). The machine-learning algorithms use features for analyzing the data to generate an assessment. Each of the features is an individual measurable property of a phenomenon being observed. The concept of a feature is related to that of an explanatory variable used in statistical techniques such as linear regression. Choosing informative, discriminating, and independent features is important for the effective operation of the pattern recognition, classification, and regression. Features may be of different types, such as numeric features, strings, and graphs.

In one example, the features may be of different types and may include one or more of content, concepts, attributes, historical data, and/or user data, merely for example. The machine-learning algorithms use the training data to find correlations among the identified features that affect the outcome or assessment. In some examples, the training data includes labeled data, which is known data for one or more identified features and one or more outcomes, such as detecting communication patterns, detecting the meaning of the message, generating a summary of a message, detecting action items in messages detecting urgency in the message, detecting a relationship of the user to the sender, calculating score attributes, calculating message scores, detecting an error in an uncorrected gaze vector, etc.

With the training data and the identified features, the machine-learning tool is trained at machine-learning program training. The machine-learning tool appraises the value of the features as they correlate to the training data. The result of the training is the trained machine-learning program. When the trained machine-learning program is used to perform an assessment, new data is provided as an input to the trained machine-learning program, and the trained machine-learning program generates the assessment as output.

The machine-learning program supports two types of phases, namely a training phase and prediction phase. In training phases, supervised learning, unsupervised learning, or reinforcement learning may be used. For example, the machine-learning program (1) receives features (e.g., as structured or labeled data in supervised learning) and/or (2) identifies features (e.g., unstructured or unlabeled data for unsupervised learning) in training data. In prediction phases, the machine-learning program uses the features for analyzing query data to generate outcomes or predictions (as examples of an assessment).

In the training phase, feature engineering is used to identify features and may include identifying informative, discriminating, and independent features for the effective operation of the machine-learning program in pattern recognition, classification, and regression. In some examples, the training data includes labeled data, which is known data for pre-identified features and one or more outcomes. Each of the features may be a variable or attribute, such as individual measurable property of a process, article, system, or phenomenon represented by a data set (e.g., the training data).

In training phases, the machine-learning program uses the training data to find correlations among the features that affect a predicted outcome or assessment. With the training data and the identified features, the machine-learning program is trained during the training phase at machine-learning program training. The machine-learning program appraises values of the features as they correlate to the training data. The result of the training is the trained machine-learning program (e.g., a trained or learned model).

Further, the training phases may involve machine learning, in which the training data is structured (e.g., labeled during preprocessing operations), and the trained machine-learning program implements a relatively simple neural network capable of performing, for example, classification and clustering operations. In other examples, the training phase may involve deep learning, in which the training data is unstructured, and the trained machine-learning program implements a deep neural network that is able to perform both feature extraction and classification/clustering operations.

A neural network generated during the training phase, and implemented within the trained machine-learning program, may include a hierarchical (e.g., layered) organization of neurons. For example, neurons (or nodes) may be arranged hierarchically into a number of layers, including an input layer, an output layer, and multiple hidden layers. Each of the layers within the neural network can have one or many neurons, and each of these neurons operationally computes a small function (e.g., activation function). For example, if an activation function generates a result that transgresses a particular threshold, an output may be communicated from that neuron (e.g., transmitting neuron) to a connected neuron (e.g., receiving neuron) in successive layers. Connections between neurons also have associated weights, which defines the influence of the input from a transmitting neuron to a receiving neuron.

In some examples, the neural network may also be one of a number of different types of neural networks, including a single-layer feed-forward network, an Artificial Neural Network (ANN), a Recurrent Neural Network (RNN), a symmetrically connected neural network, and unsupervised pre-trained network, a Convolutional Neural Network (CNN), a Generative Adversarial Network (GAN), and/or a Recursive Neural Network (RNN), merely for example.

During prediction phases, the trained machine-learning program is used to perform an assessment. Query data is provided as an input to the trained machine-learning program, and the trained machine-learning program generates the assessment as output, responsive to receipt of the query data.

A compliance system 232 facilitates compliance by the digital interaction system 100 with data privacy and other regulations, including for example the California Consumer Privacy Act (CCPA), General Data Protection Regulation (GDPR), and Digital Services Act (DSA). The compliance system 232 comprises several components that address data privacy, protection, and user rights, ensuring a secure environment for user data. A data collection and storage component securely handles user data, using encryption and enforcing data retention policies. A data access and processing component provides controlled access to user data, ensuring compliant data processing and maintaining an audit trail. A data subject rights management component facilitates user rights requests in accordance with privacy regulations, while the data breach detection and response component detects and responds to data breaches in a timely and compliant manner. The compliance system 232 also incorporates opt-in/opt-out management and privacy controls across the digital interaction system 100, empowering users to manage their data preferences. The compliance system 232 is designed to handle sensitive data by obtaining explicit consent and implementing strict access controls, in accordance with applicable laws.

### Data Architecture

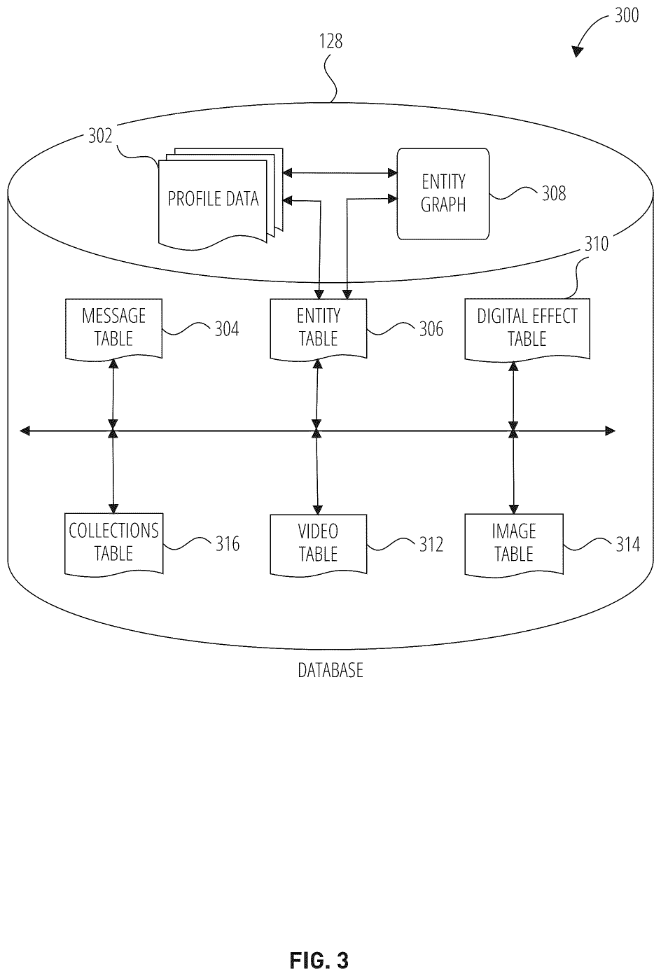

FIG. 3 is a schematic diagram illustrating data structures 300, which may be stored in the database 128 of the server system 110, according to certain examples. While the content of the database 128 is shown to comprise multiple tables, it will be appreciated that the data could be stored in other types of data structures (e.g., as an object-oriented database).

The database 128 includes message data stored within a message table 304. This message data includes at least message sender data, message recipient (or receiver) data, and a payload. Further details regarding information that may be included in a message, and included within the message data stored in the message table 304, are described below with reference to FIG. 3.

An entity table 306 stores entity data, and is linked (e.g., referentially) to an entity graph 308 and profile data 302. Entities for which records are maintained within the entity table 306 may include individuals, corporate entities, organizations, objects, places, events, and so forth. Regardless of entity type, any entity regarding which the server system 110 stores data may be a recognized entity. Each entity is provided with a unique identifier, as well as an entity type identifier (not shown).

The entity graph 308 stores information regarding relationships and associations between entities. Such relationships may be social, professional (e.g., work at a common corporation or organization), interest-based, or activity-based, merely for example. Certain relationships between entities may be unidirectional, such as a subscription by an individual user to digital content of a commercial or publishing user (e.g., a newspaper or other digital media outlet, or a brand). Other relationships may be bidirectional, such as a “friend” relationship between individual users of the digital interaction system 100.

Certain permissions and relationships may be attached to each relationship, and to each direction of a relationship. For example, a bidirectional relationship (e.g., a friend relationship between individual users) may include authorization for the publication of digital content items between the individual users, but may impose certain restrictions or filters on the publication of such digital content items (e.g., based on content characteristics, location data or time of day data). Similarly, a subscription relationship between an individual user and a commercial user may impose different degrees of restrictions on the publication of digital content from the commercial user to the individual user, and may significantly restrict or block the publication of digital content from the individual user to the commercial user. A particular user, as an example of an entity, may record certain restrictions (e.g., by way of privacy settings) in a record for that entity within the entity table 306. Such privacy settings may be applied to all types of relationships within the context of the digital interaction system 100, or may selectively be applied to certain types of relationships.

The profile data 302 stores multiple types of profile data about a particular entity. The profile data 302 may be selectively used and presented to other users of the digital interaction system 100 based on privacy settings specified by a particular entity. Where the entity is an individual, the profile data 302 includes, for example, a username, telephone number, address, settings (e.g., notification and privacy settings), as well as a user-selected avatar representation (or collection of such avatar representations). A particular user may then selectively include one or more of these avatar representations within the content of messages communicated via the digital interaction system 100, and on map interfaces displayed by interaction clients 104 to other users. The collection of avatar representations may include “status avatars,” which present a graphical representation of a status or activity that the user may select to communicate at a particular time.

Where the entity is a group, the profile data 302 for the group may similarly include one or more avatar representations associated with the group, in addition to the group name, members, and various settings (e.g., notifications) for the relevant group.

The database 128 also stores digital effect data, such as overlays or filters, in a digital effect table 310. The digital effect data is associated with and applied to videos (for which data is stored in a video table 312) and images (for which data is stored in an image table 314).

Filters, in some examples, are overlays that are displayed as overlaid on an image or video during presentation to a recipient user. Filters may be of various types, including user-selected filters from a set of filters presented to a sending user by the interaction client 104 when the sending user is composing a message. Other types of filters include geolocation filters (also known as geo-filters), which may be presented to a sending user based on geographic location. For example, geolocation filters specific to a neighborhood or special location may be presented within a user interface by the interaction client 104, based on geolocation information determined by a Global Positioning System (GPS) unit of the user system 102.

Another type of filter is a data filter, which may be selectively presented to a sending user by the interaction client 104 based on other inputs or information gathered by the user system 102 during the message creation process. Examples of data filters include current temperature at a specific location, a current speed at which a sending user is traveling, battery life for a user system 102, or the current time.

Other digital effect data that may be stored within the image table 314 includes augmented reality content items (e.g., corresponding to augmented reality experiences). An augmented reality content item may be a real-time special effect and sound that may be added to an image or a video.

A collections table 316 stores data regarding collections of messages and associated image, video, or audio data, which are compiled into a collection (e.g., a narrative or a gallery). The creation of a particular collection may be initiated by a particular user (e.g., each user for which a record is maintained in the entity table 306). A user may create a “personal collection” in the form of a collection of content that has been created and sent/broadcast by that user. To this end, the user interface of the interaction client 104 may include an icon that is user-selectable to enable a sending user to add specific content to his or her personal narrative.

A collection may also constitute a “live collection,” which is a collection of content from multiple users that is created manually, automatically, or using a combination of manual and automatic techniques. For example, a “live collection” may constitute a curated stream of user-submitted content from various locations and events. Users whose client devices have location services enabled and are at a common location event at a particular time may, for example, be presented with an option, via a user interface of the interaction client 104, to contribute content to a particular live collection. The live collection may be identified to the user by the interaction client 104, based on his or her location.

A further type of content collection is known as a “location collection,” which enables a user whose user system 102 is located within a specific geographic location (e.g., on a college or university campus) to contribute to a particular collection. In some examples, a contribution to a location collection may employ a second degree of authentication to verify that the end-user belongs to a specific organization or other entity (e.g., is a student on the university campus).

As mentioned above, the video table 312 stores video data that, in some examples, is associated with messages for which records are maintained within the message table 304. Similarly, the image table 314 stores image data associated with messages for which message data is stored in the entity table 306. The entity table 306 may associate various digital effects from the digital effect table 310 with various images and videos stored in the image table 314 and the video table 312.

The databases 128 also include an inventory of items or objects which the eye tracking system 504 has identified as being of interest to the user of the head-wearable apparatus 116. For example, the eye tracking system 504 can determine that a user has focused their attention on a particular object in the field of view of the head-wearable apparatus 116. In such cases, the eye tracking system 504 determines that focus on the particular object satisfies a fixation parameter (e.g., the user gazed in a direction of the particular object for longer than a threshold period of time, such as two seconds). In such cases, the eye tracking system 504 can segment and identify a classification of the particular object and add the object to the inventor of items or objects. After an object remains in the inventory of items or objects for more than a threshold period of time (e.g., more than two days), the object is removed from the inventory of items or objects.

### Data Communications Architecture

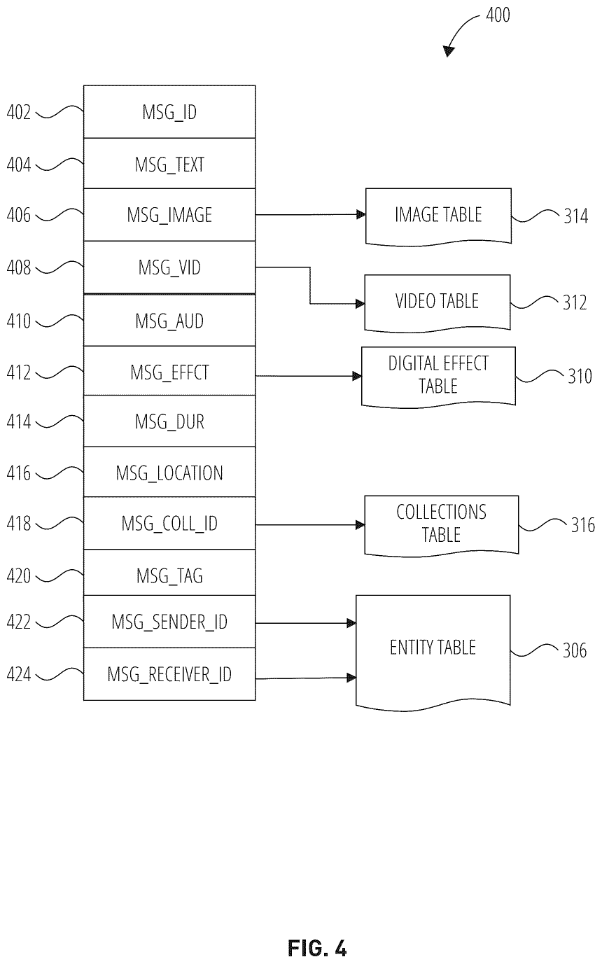

FIG. 4 is a schematic diagram illustrating a structure of a message 400, according to some examples, generated by an interaction client 104 for communication to a further interaction client 104 via the servers 124. The content of a particular message 400 is used to populate the message table 304 stored within the database 128, accessible by the servers 124. Similarly, the content of a message 400 is stored in memory as “in-transit” or “in-flight” data of the user system 102 or the servers 124. A message 400 is shown to include the following example components:
Message identifier 402: a unique identifier that identifies the message 400.
Message text payload 404: text, to be generated by a user via a user interface of the user system 102, and that is included in the message 400.
Message image payload 406: image data, captured by a camera component of a user system 102 or retrieved from a memory component of a user system 102, and that is included in the message 400. Image data for a sent or received message 400 may be stored in the image table 314.
Message video payload 408: video data, captured by a camera component or retrieved from a memory component of the user system 102, and that is included in the message 400. Video data for a sent or received message 400 may be stored in the video table 312.
Message audio payload 410: audio data, captured by a microphone or retrieved from a memory component of the user system 102, and that is included in the message 400.
Message digital effect data 412: digital effect data (e.g., filters, stickers, or other annotations or enhancements) that represents digital effects to be applied to message image payload 406, message video payload 408, or message audio payload 410 of the message 400. Digital effect data for a sent or received message 400 may be stored in the digital effect table 310.
Message duration parameter 414: parameter value indicating, in seconds, the amount of time for which content of the message (e.g., the message image payload 406, message video payload 408, message audio payload 410) is to be presented or made accessible to a user via the interaction client 104.
Message geolocation parameter 416: geolocation data (e.g., latitudinal, and longitudinal coordinates) associated with the content payload of the message. Multiple message geolocation parameter 416 values may be included in the payload, each of these parameter values being associated with respect to content items included in the content (e.g., a specific image within the message image payload 406, or a specific video in the message video payload 408).
Message collection identifier 418: identifier values identifying one or more content collections (e.g., “stories” identified in the collections table 316) with which a particular content item in the message image payload 406 of the message 400 is associated. For example, multiple images within the message image payload 406 may each be associated with multiple content collections using identifier values.
Message tag 420: each message 400 may be tagged with multiple tags, each of which is indicative of the subject matter of content included in the message payload. For example, where a particular image included in the message image payload 406 depicts an animal (e.g., a lion), a tag value may be included within the message tag 420 that is indicative of the relevant animal. Tag values may be generated manually, based on user input, or may be automatically generated using, for example, image recognition.
Message sender identifier 422: an identifier (e.g., a messaging system identifier, email address, or device identifier) indicative of a user of the user system 102 on which the message 400 was generated and from which the message 400 was sent.
Message receiver identifier 424: an identifier (e.g., a messaging system identifier, email address, or device identifier) indicative of a user of the user system 102 to which the message 400 is addressed.

The contents (e.g., values) of the various components of message 400 may be pointers to locations in tables within which content data values are stored. For example, an image value in the message image payload 406 may be a pointer to (or address of) a location within an image table 314. Similarly, values within the message video payload 408 may point to data stored within a video table 312, values stored within the message digital effect data 412 may point to data stored in a digital effect table 310, values stored within the message collection identifier 418 may point to data stored in a collections table 316, and values stored within the message sender identifier 422 and the message receiver identifier 424 may point to user records stored within an entity table 306.

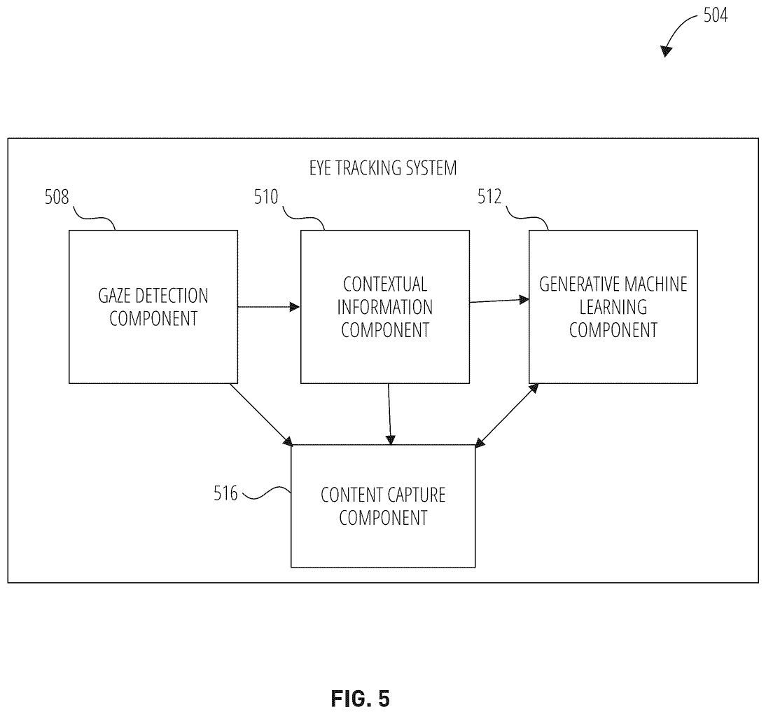

FIG. 5 illustrates a diagram of an eye tracking system 504, according to some examples. The eye tracking system 504 can include a gaze detection component 508, a contextual information component 510, a content capture component 516, and/or a generative machine learning component 512. The eye tracking system 504 can be integrated as part of the head-wearable apparatus 116 or can be implemented at least in part by an external device, such as an interaction client 104.

The gaze detection component 508 is responsible for accessing eye gaze information associated with the field of view of a head-wearable apparatus. This gaze detection component 508 obtains detailed eye gaze data, including the gaze vector, vergence angle, and pupil diameter associated with the user's eye. The gaze vector is a three-dimensional representation of the direction in which the user's eyes are looking, originating from the center of the eye. To generate this information, the gaze detection component 508 can utilize a combination of hardware and software technologies. On the hardware side, the gaze detection component 508 may employ infrared cameras and emitters, such as those mentioned in the head-wearable apparatus description (infrared emitter 908 and infrared camera 910).

These infrared components can accurately track eye movements and pupil dilation without interfering with the user's vision. The gaze vector is calculated using techniques such as pupil center corneal reflection or video-based eye tracking. This involves analyzing the position of the pupil relative to corneal reflections created by infrared light sources.

The vergence angle, which refers to the angle between the visual axes of the two eyes when focused on an object, can be computed by tracking the relative positions of both eyes simultaneously. This information can be used to estimate the depth at which the user is attending.

Pupil diameter can be measured using high-speed cameras with infrared illumination, allowing for accurate detection of pupil dilation and constriction. This data can provide insights into cognitive load, emotional state, or level of interest. The gaze detection component 508 also processes the raw eye tracking data to identify specific eye movement patterns. The gaze detection component 508 can detect fixations, which are periods when the eyes are relatively stable (e.g., lasting between 200-300 milliseconds), by identifying when gaze velocity falls below a certain threshold, such as 30 degrees per second.

Saccades, which are rapid eye movements between fixations, can be detected by identifying periods of high gaze velocity, such as above 30 degrees per second. Additional metrics such as blink rate, microsaccades, or smooth pursuit movements may also be recorded and analyzed by the gaze detection component 508. The gaze detection component 508 can use a combination of hardware (e.g., infrared cameras, illuminators) and software algorithms to capture and process this data in real-time, providing a continuous stream of information about the user's visual attention and potential cognitive state.

The gaze detection component 508 may also employ machine learning algorithms to improve the accuracy of its eye tracking measurements over time, adapting to individual users'eye movement patterns and characteristics. All of this information is then passed on to the contextual information component 510 for further processing and analysis, forming the foundation for the ability of the eye tracking system 504 to infer user attention, task engagement, and cognitive state.

For example, the contextual information component 510 receives the eye gaze information from the gaze detection component 508 and generates contextual information based on this data. This contextual information component 510 processes the eye gaze information to infer attention information, task information, and cognitive state using fixation information and saccade data of the eye. Fixation information represents intervals when the eye is relatively stable, typically lasting between 200-300 milliseconds, while saccades are rapid eye movements between fixations.

In some cases, the contextual information component 510 can determine that, based on the information received from the gaze detection component 508, the user is reading text visible in the field of view of the head-wearable apparatus 116. The text can be in a book and part of multiple paragraphs/passages on a page of the book and/or can be written on a sign in the field of view of the head-wearable apparatus 116. In response to determining that the contextual information indicates that the user of the head-wearable apparatus 116 is reading the text visible in the field of view, the contextual information component 510 can generate a prompt with an instruction for the generative machine learning component 512 to process the text that is visible in the field of view and disregard other objects in the same field of view.

To do so, the contextual information component 510 can instruct the content capture component 516 to selectively capture content that includes the text that the user is focusing on, an image, or other scene descriptor. The content capture component 516 can crop out of an image obtained by a world-facing camera of the content capture component 516 portions of the image that exclude the text that the user is focusing on. The content capture component 516 can then provide an image with the cropped out portions to the generative machine learning component 512, such as by including the cropped portions of the image in the prompt that is provided to the generative machine learning component 512. For example, if the gaze is directed at a particular sentence or passage of multiple passages of a book, the content capture component 516 can crop out the image to only include the passage that is being focused on by the user and discarding other passages. To save power, re-fixations or fixation durations can be used rather than using a sample-level gaze position. In some cases, the content capture component 516 can receive information from the contextual information component 510 indicating that a particular text or passage has been read or re-read multiple times within a certain period (e.g., in less than one minute). In such cases, the content capture component 516 can crop out that portion of text that has been re-read multiple times and provide information in the prompt indicating that the portion of text has been re-read multiple times. The generative machine learning component 512 can generate related information, such as an explanation, in response to determining that the prompt indicates that the text has been re-read multiple times in the certain period.

The generative machine learning component 512 can then process the prompt to generate various outputs relating to the text. For example, the generative machine learning component 512 can generate a translation of the text. In some cases, the generative machine learning component 512 can provide additional context information associated with the text. To do so, the generative machine learning component 512 can perform optical character recognition on the text in the image to convert the image of the text into optical characters and to generate, as the output, content related to the text that is in the image.

In some examples, the generative machine learning component 512, in response to determining that the contextual information indicates that the portion of the text has been read by the user multiple times, determines that the user is having comprehension difficulties. In response, the generative machine learning component 512 provides or generates information indicating that the user is having comprehension difficulties. The output of the generative machine learning component 512 can be generated by associating a greater weight with the portion of the text that has been re-read multiple times over other portions of the text. For example, the content capture component 516 can provide an image that includes all of the text on a given page of the book from multiple passages and the generative machine learning component 512 can provide related content by assigning a greater weight to the portion of text that has been re-read over other text in the image. For example, regressive saccades can indicate re-reading. If a given piece of text is re-read (e.g., refixated), then this could provide implicit input to the generative machine learning component 512 that the user is having comprehension or concentration difficulties. This information can be used to place greater weight on those re-read words and phrases to the generative machine learning component 512 by, for example, inputting that text multiple times or with specific phrases such as “what does x mean” or “explain x in the context of the rest of this passage.”

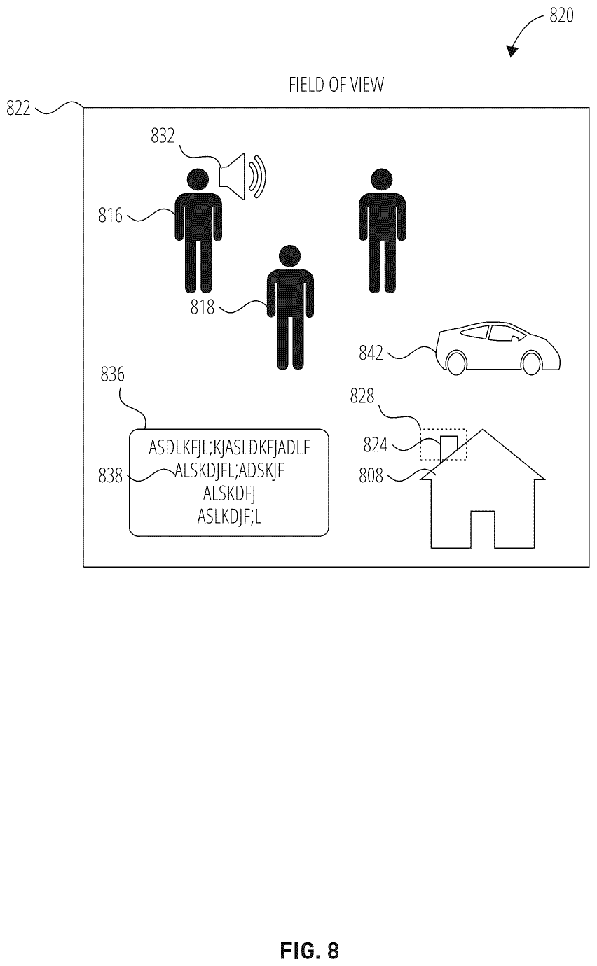

For example, as shown in the diagram 820 of FIG. 8, the head-wearable apparatus 116 can be used by a user to view a field of view 822. The field of view 822 can include real and/or virtual objects and can include an image or no images at all. One or more images of the field of view 822 can be captured by the content capture component 516 and processed by the generative machine learning component 512. Specifically, the field of view 822 can include an object with text 836. The content capture component 516 can capture an image of the object with the text 836. The content capture component 516 can determine that a gaze is directed towards a portion of text 838. In such cases, the content capture component 516 can crop the image to only include the portion of text 838 and provide that cropped portion to the generative machine learning component 512 to generate an output (e.g., a translation or explanation of the portion of text 838).

In some examples, humans tend to spend much of their gaze time looking primarily at the eyes of other humans and animals and secondarily at the mouths. These gaze patterns can indicate to the generative machine learning component 512 that the user was focusing on the human or animal itself and not, for example, looking at its clothing or at a very nearby object. For example, if asked to identify a person's wealth, people may look at clothing and when asked to identify age, they may look at the face. Given that gaze may be tied to a user's cognitive state, the generative machine learning component 512 can use the differences in the spatiotemporal dynamics of gaze to implicitly infer a user's tasks and goals. This, in turn, can allow the generative machine learning component 512 to provide better recommendations to the user.

In some examples, the contextual information component 510 can also control notifications that are presented to the user of the head-wearable apparatus 116 based on the information received from the gaze detection component 508. Pupil diameter dynamics are predictors of cognitive load (mental effort; task difficulty), engagement, and emotion. When a user's working memory is near or at capacity, the pupils may dilate. The gaze detection component 508 and the contextual information component 510 can estimate some other cues of cognitive state based on frequency analysis of microsaccades. These potentially could be additional cues for the generative machine learning component 512 to know that a user is heavily engaged with a specific task or that there is an emotionally salient stimulus present. In such cases, the generative machine learning component 512 can instruct the contextual information component 510 to reduce the number of visual notifications presented on the head-wearable apparatus 116 so that the user can better focus.

The content capture component 516 is responsible for capturing images or video of the field of view of the head-wearable apparatus 116. This content capture component 516 continuously records video of the field of view in a video buffer, representing images seen within a past threshold interval. Each time point in the video includes information that indicates the user's gaze relative to objects (real and/or virtual) in a field of view of the head-wearable apparatus 116.

The generative machine learning component 512 processes the contextual information and at least one image of the field of view to generate an output. This generative machine learning component 512 may include one or more LLMs and is capable of performing various tasks such as optical character recognition, object segmentation, and generating contextually relevant responses.

The eye tracking system 504 operates by continuously collecting and analyzing eye tracking data. When the user focuses on a particular object or area in their environment or field of view (including images and/or real-world objects), the content capture component 516 analyzes this information in conjunction with camera input. The generative machine learning component 512 then processes this data to generate contextually relevant information about the object or area of focus.

For example, the content capture component 516 can receive information from the contextual information component 510 that the user is focusing on a particular portion of an object (e.g., a top of a mountain visible in the field of view of the content capture component 516). In such cases, the content capture component 516 can capture an image of the field of view that includes the object and can crop the particular portion of the object from the image. The content capture component 516 can provide the cropped portion of the image as part of a prompt that includes instructions for the generative machine learning component 512 to generate content or an image that includes a modifications to the particular portion. For example, a user may want to have the generative machine learning component 512 generate an image of a particular mountain range in a different season. The user may look at the specific mountain range and give a verbal prompt to the system such as “How would these mountains look in the snow?” Because people typically fixate horizon lines, the previous and current fixated positions on the mountain can be used to provide the generative machine learning component 512 context for where to add snow (e.g., by providing a task-relevant cropped version of the mountain range) and input that to generative machine learning component 512 as an image-to-image generation along with the textual input of “these mountains in the snow.”

For example, the field of view 822 can include an object 808 and one or more other objects 842. In such cases, the content capture component 516 can determine that the gaze detection component 508 indicates that the user is gazing at the object 808 and not the other objects 842. The content capture component 516 can then crop the image to only depict the object 808. Also, the content capture component 516 can determine that the gaze is directed towards the portion of the object 824. The content capture component 516 can further crop the image to only depict the portion of the object 824. The content capture component 516 can provide the cropped portion 828 to the generative machine learning component 512 with the prompt to perform the modification to the cropped portion 828. The content capture component 516 can then receive the modification from the generative machine learning component 512 and can replace the portion of the object 824 with the modified portion of the portion of the object 824. In some cases, the content capture component 516 provides both the portion of the object 824 and the object 808 to the generative machine learning component 512. The generative machine learning component 512 can then generate a new image that depicts the object 808 with a modified version of the portion of the object 824.

For text-based interactions, the eye tracking system 504 can determine if the user is reading text visible in the field of view. In such cases, the eye tracking system 504 generates a prompt instructing the generative machine learning component 512 to process the visible text and disregard other objects in the same field of view. The eye tracking system 504 can perform optical character recognition on the text in the image to convert it into optical characters and generate content related to the text.

The eye tracking system 504 also handles more complex scenarios, such as when a user is focusing on different portions of an object. The eye tracking system 504 can determine spatiotemporal dynamics associated with these different portions, indicating which parts of the object the user is focusing on over time. This information is then provided to the generative machine learning component 512 to generate relevant content.

The eye tracking system 504 is capable of processing voice commands in conjunction with eye tracking data. For example, if a user requests a modification to an object visible in the field of view, the eye tracking system 504 can generate a new image that includes the modification, applying it to the specific portion of the object the user was focusing on.

To optimize processing, the eye tracking system 504 employs techniques such as applying a Gaussian blur kernel to regions in frames that exceed the user's gaze by more than a specified threshold. The eye tracking system 504 also discards frames that fail to satisfy a fixation parameter of the eye and aligns the remaining set of frames. In some cases, the content capture component 516 can use eye tracking information received from the gaze detection component 508 in a few ways to precondition the input image(s) or captured image to minimize the transmission of irrelevant information to the user's query or task. For example, the content capture component 516 can constantly record the last 30 seconds of video in a video buffer. Frames of the video captured after the video buffer is full are written over and in place of frames stored at a head of the video buffer. Namely, the video buffer only stores the most recently captured video frames in the previous 30 second interval (or some other time interval) from one or more world-facing cameras. These cameras can be calibrated along with the eye tracking system 504 to understand where in world coordinates the user is fixating at any moment in time. When a user prompts the eye tracking system 504 to generate some content, the eye tracking system 504 can access the preceding t seconds of image frames (e.g., the last five seconds of video frames stored in the video buffer) and apply a Gaussian blur kernel to the images for all regions of the frames other than the user's gaze position and a ˜3° radial region surrounding the gaze vector (to account for foveal field of view (FOV) and accuracy of the eye tracking system). This generates a series of N images.

For example, the gaze detection component 508 calculates the user's gaze vector, which represents the direction of the user's focus in three-dimensional space. Based on this gaze vector, the gaze detection component 508 defines a circular region with a radius of approximately 3° around the point where the gaze vector intersects with the image plane. This preserved region corresponds to the foveal field of view and accounts for the accuracy limitations of the eye tracking system 504.

For each frame in the series of N images stored in the video buffer, the eye tracking system 504 (e.g., the content capture component 516) applies a Gaussian blur kernel to all pixels outside the defined 3° radial region. The Gaussian blur uses a Gaussian function to calculate the transformation applied to each pixel in the image. To create a more natural transition between the clear and blurred areas, the eye tracking system 504 may implement a gradient of blur intensity, where the blur becomes progressively stronger as the distance from the center of the preserved region increases.

This blurring operation is performed on each frame individually, as the user's gaze position may change from frame to frame. This ensures that the preserved clear region accurately follows the user's attention throughout the sequence of images. Given the need for real-time responsiveness, the eye tracking system 504 can employ optimized image processing algorithms and may utilize GPU acceleration to handle the computational load efficiently. The blurring process is integrated with the video buffer system, which continuously records and stores the most recent frames. When content generation is triggered, the eye tracking system 504 retrieves the relevant frames from this buffer for processing. This technical implementation allows the eye tracking system 504 to create a series of images that emphasize the user's visual focus while de-emphasizing peripheral areas, thereby providing a more targeted input for the generative machine learning component 512.

In some cases, eye tracking can be used to reduce irrelevant information by only using frames corresponding to fixation centroids. Because visual input is suppressed during saccades, the computational complexity of this endeavor can be simplified further by only using frames corresponding to the centroid of a fixation. The world coordinates corresponding to the centroid of a fixation can capture the same spatiotemporal context as using the raw gaze vector but will be computationally less complex and more faithful to human vision/perception. Specifically, a user may fixate approximately three times per second. If the frames corresponding to fixation from the prior 30 seconds of video are used, then only using the frames corresponding to fixation centroids can reduce the number of frames used to approximately 10 (as opposed to 30 s*120 Hz=3600 frames assuming 120 Hz world-facing camera frame rate).

Together, this allows the eye tracking system 504 to reduce both the spatial windows required as input to the LMM (by inferring the foveal focus of attention) as well as the number of frames by using the knowledge that visual input is optimized during fixation and suppressed during saccades. Depending on the application and duration t, the frames corresponding to the focus of visual attention could be spatially aligned and stacked (when there is no head/body movement resulting in no change in the scene's spatial layout) or stitched (when head/body movement is present that results in a change to the scene's spatial layout) such that the un-blurred regions of each image are included in the final output image and regions that were never gazed upon in that time t remain blurry. This image is the input to the generative machine learning component 512 along with the textual prompt generated by a speech-to-text conversion. The duration t can be tuned based on specific query types, the user's task, and gaze dynamics.

The eye tracking system 504 maintains an inventory of objects that the user has focused on, which is used by the generative machine learning component 512 to respond to queries. The eye tracking system 504 classifies these objects and can automatically present information when a threshold number of objects with the same classification is reached. For example, the eye tracking system 504 can build an inventory of objects near the user based on gaze fixations and passing images from a world-facing camera into a semantic segmentation model. Each time the user fixates on an object, where fixation is defined as a period of time t where the eyes are relatively stable (e.g., gaze velocity is less than 30 degrees per second), an image can be taken by the world-facing camera, passed through a semantic segmentation model, and the object the user fixated on is added to a dynamic list of objects in an inventory.

Later, if a user produces a query, the inventory of objects can be included as contextual objects. For example, the user may ask “What can I cook with this?” and objects semantically identified as food or ingredients can be included as text as additional input to the generative machine learning component 512 while non-food items are ignored. The inventory can also be used to predict the user's query even without the user explicitly starting a query. Using the similar food-based example, if the user indicates that they wish to begin verbalizing a query and the inventory contains a plurality of food items, the generative machine learning component 512 could display a proposed query such as “What can I cook with these ingredients?”

Additionally, the eye tracking system 504 can adjust its output based on the user's cognitive load, as determined by pupil diameter dynamics. If the cognitive load transgresses a threshold, the eye tracking system 504 can reduce the quantity of visual notifications provided to the user on the head-wearable apparatus 116.

In some examples, the eye tracking system 504 can process audio streams with multiple speakers, using the contextual information and image data to select and filter a particular portion of the audio stream corresponding to the speaker the user is focusing on. Specifically, the content capture component 516 can receive, from multiple microphones of the head-wearable apparatus 116, an audio stream that includes spoken content from multiple speakers in a field of view. The content capture component 516 can extract relevant speech from the environment based on information from the generative machine learning component 512 and the contextual information component 510. The eye tracking system 504 can include the world-facing camera and two or more microphones, which can be used together to predict the origination of the speech to be extracted. People generally look at the eyes or mouths of someone they are interacting with and this gaze pattern can be extracted by the gaze detection component 508. The world-facing camera combined with the eye tracker estimates the location of the speaker in world coordinates (e.g., using fixation centroids to extract the world coordinate information of where the user is focusing their attention). These coordinates can be used as input to the sound filtering system using two or more microphones to extract the directionality of the speech. The filtered speech can then be provided to the generative machine learning component 512 to perform real-time translation and provide the translated speech to the user via speakers of the head-wearable apparatus 116. For example, the field of view 822 (shown in FIG. 8) can include first person 816 and second person 818 speaking at the same time. The microphones of the head-wearable apparatus 116 can receive an audio stream 832 that includes speech of the first person 816 and second person 818. The eye tracking system 504 can access the gaze detection component 508 to determine which of the first person 816 and the second person 818 the user is focusing their attention on. Based on this information, the eye tracking system 504 can determine that the user is focusing their attention on first person 816 and, in response, can filter the speech to only include the words spoken by the first person 816 and exclude the words spoken by the second person 818. The filtered speech is provided to the generative machine learning component 512 to output content related to the speech, such as a real-time translation.

All of these components and processes work together to create a seamless, context-aware interaction between the user and the augmented reality environment, enhancing the capabilities of generative AI through the integration of eye tracking data.

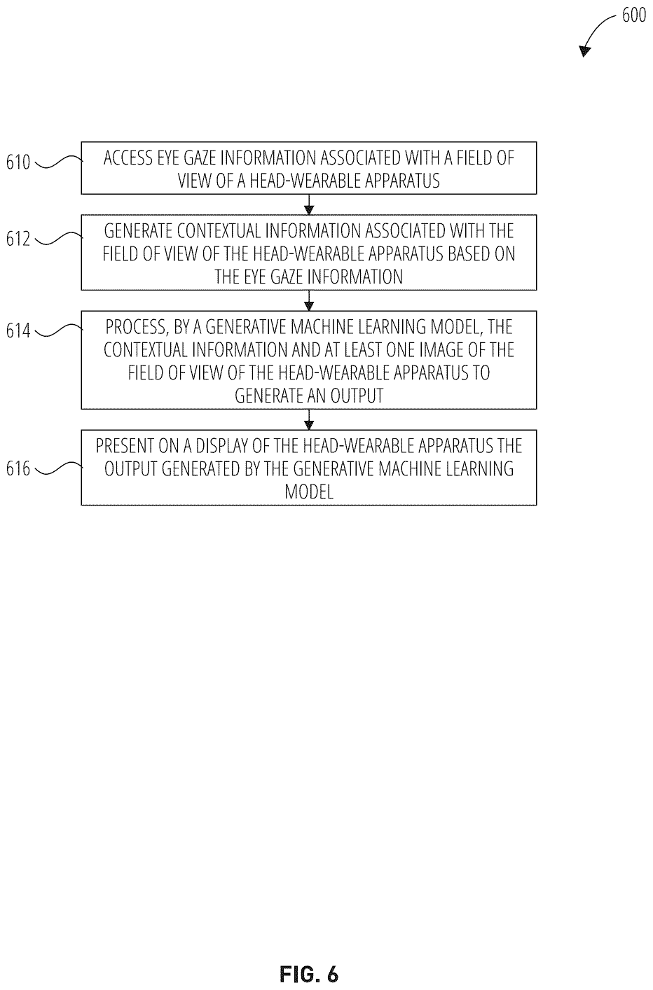

FIG. 6 is a flowchart illustrating routine 600 (e.g., a method or process), according to some examples, of enhancing generative AI outputs using eye tracking data.

Although the example method depicted in FIG. 6 depicts a particular sequence of operations, the sequence may be altered without departing from the scope of the present disclosure. For example, some of the operations depicted may be performed in parallel or in a different sequence that does not materially affect the function of the method. In some examples, different components of an example device or system that implements the method may perform functions at substantially the same time or in a specific sequence.

In operation 610, the routine 600 accesses eye gaze information associated with a field of view of a head-wearable apparatus, as discussed above.

In operation 612, the routine 600 generates contextual information associated with the field of view of the head-wearable apparatus based on the eye gaze information, as discussed above.

In operation 614, the routine 600 processes, by a generative machine learning model, the contextual information and content associated with the field of view, such as at least one image of the field of view, a scene descriptor, or voice input of the head-wearable apparatus to generate an output, as discussed above.

In operation 616, the routine 600 presents the output generated by the generative machine learning model on a display of the head-wearable apparatus, as discussed above.

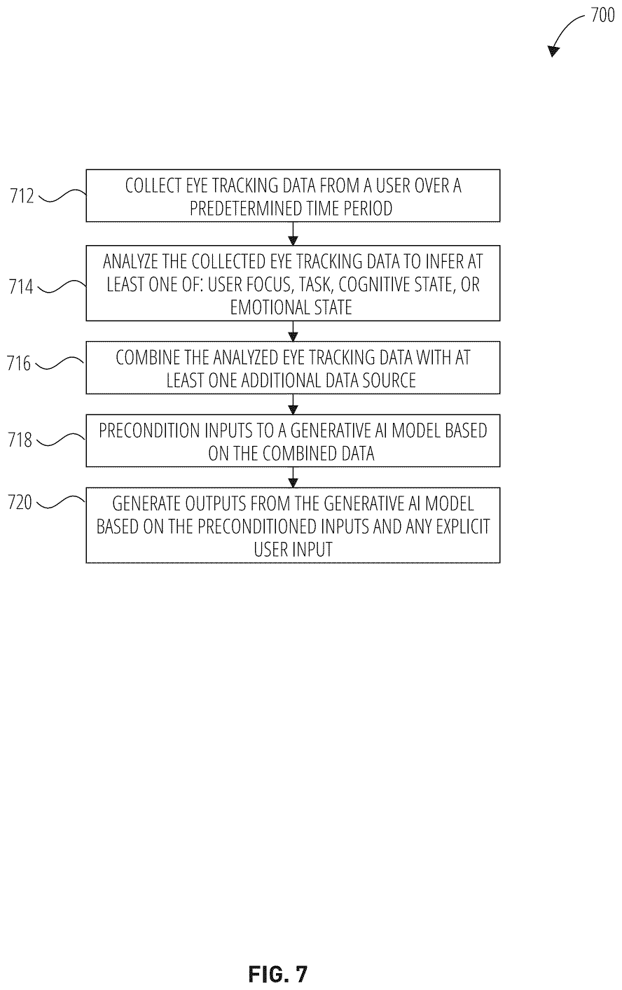

FIG. 7 is a flowchart illustrating routine 700 (e.g., a method or process), according to some examples, of enhancing generative AI outputs using eye tracking data. Traditional generative AI models lack real-time contextual information about the user's focus, cognitive state, and environment, leading to less relevant or personalized outputs. To address this technical problem, the disclosed system collects and analyzes eye tracking data in real-time to infer the user's focus, task, and cognitive state, This data is combined with inputs from environmental sensors, microphones, and cameras to create a rich contextual understanding. The integration system merges these diverse data sources, allowing the generative AI model to produce outputs that are more relevant to the user's current state and environment. For example, the system can use gaze patterns to identify objects of interest in the user's field of view, enabling the AI to generate more targeted and contextually appropriate responses. This reduces computational load and improves efficiency.

Although the example method depicted in FIG. 7 depicts a particular sequence of operations, the sequence may be altered without departing from the scope of the present disclosure. For example, some of the operations depicted may be performed in parallel or in a different sequence that does not materially affect the function of the method. In some examples, different components of an example device or system that implements the method may perform functions at substantially the same time or in a specific sequence.

In operation 712, routine 700 collects eye tracking data from a user over a predetermined time period, as discussed above.

In operation 714, routine 700 analyzes the collected eye tracking data to infer at least one of: user focus, task, cognitive state, or emotional state. For example, the system gathers visual attention data from the user. This process operates continuously during device usage to provide insights into the user's visual behavior and cognitive processes. The eye tracking system can collect biometric data related to eye movements and characteristics. This data may include various measurements that indicate where and how a user is looking at their environment, as discussed above.

In operation 716, routine 700 combines the analyzed eye tracking data with at least one additional data source, as discussed above. For example, the eye tracking system may measure and record several types of eye-related data. This data may include the direction of the user's gaze, the convergence of the eyes, the size of the pupils, periods of visual focus, and rapid eye movements.

The eye tracking system may collect various types of data. For example, the eye tracking system can collect or generate a gaze vector. This measurement indicates the direction of the user's gaze in three-dimensional space. It may be calculated using techniques such as pupil center corneal reflection or video-based eye tracking. The eye tracking system can collect vergence angle, which refers to the angle between the visual axes of the two eyes when focused on an object. It may be used to estimate the depth at which the user is focusing. The eye tracking system can collect pupil diameter. This measurement of pupil size may be used to infer cognitive load, emotional state, or level of interest. The system may use infrared illumination and high-speed cameras to accurately measure pupil dilation and constriction. The eye tracking system can collect fixations. These are periods when the eyes are relatively stable, typically lasting between 200-300 milliseconds. The system may identify fixations by detecting when gaze velocity falls below a certain threshold, such as 30 degrees per second. The eye tracking system can collect saccades. These are rapid, ballistic eye movements between fixations. The system may detect saccades by identifying periods of high gaze velocity, typically above 30 degrees per second.

The eye tracking system may also record additional metrics such as blink rate, microsaccades, or smooth pursuit movements. The system may use a combination of hardware (e.g., infrared cameras, illuminators) and software algorithms to capture and process this data in real-time, providing a continuous stream of information about the user's visual attention and potential cognitive state. The eye tracking system (e.g., a data processor of the head-wearable apparatus 116) processes the collected eye tracking information over a specified timeframe to extract meaningful insights about the user's visual behavior and attention patterns. The system examines the eye tracking data to identify recurring patterns and changes in the user's visual focus and eye movements. This analysis may cover a period of at least one second to capture temporal trends in user attention.

For example, the eye tracking system can perform fixation analysis, such as by examining the duration, frequency, and spatial distribution of fixations to determine areas of sustained visual interest. The eye tracking system can perform saccade analysis, such as by analyzing the velocity, direction, and frequency of rapid eye movements to understand how the user scans their environment. The eye tracking system can perform pupil diameter analysis, such as by tracking changes in pupil size over time to infer cognitive load or emotional responses. The eye tracking system can perform scanpath analysis, such as by examining the sequence and timing of fixations and saccades to identify characteristic patterns associated with specific tasks or cognitive processes. The eye tracking system can perform Area of Interest (AOI) analysis, such as by defining regions in the visual field and analyzing how attention is distributed among these areas over time. The eye tracking system can perform Recurrence Quantification Analysis (RQA), such as by applying non-linear time series analysis to detect recurring patterns in eye movements, which may indicate shared attention in collaborative tasks. The eye tracking system can perform microsaccade analysis, such as by examining the frequency and characteristics of tiny, involuntary eye movements to infer cognitive states such as fatigue or attentiveness.

In operation 718, routine 700 preconditions inputs to a generative AI model based on the combined data. Specifically, the eye tracking system may use machine learning algorithms to process this data, identifying trends and patterns that may not be immediately apparent. This temporal analysis allows the system to build a comprehensive understanding of the user's attention dynamics, which can be used to inform subsequent processing steps and ultimately enhance the relevance of generative AI outputs. The system utilizes the analyzed eye tracking data to deduce various aspects of the user's state without requiring explicit input.

For example, the eye tracking system can analyze eye tracking data and categorize it into distinct aspects of the user's state, such as focus. The system may determine the user's current visual focus based on fixation patterns and gaze dynamics. This information can help identify areas of interest in the user's field of view. The system can determine task information. Namely, the system may infer the user's current task or activity based on eye movement patterns and scanpath shapes. Different tasks often produce distinct eye movement signatures. Cognitive state can be estimated to determine or estimate the user's cognitive load, engagement level, or emotional state based on pupil diameter dynamics and other eye tracking metrics. The system may analyze fixation duration and frequency to identify areas of sustained visual attention. It may also use saccade patterns to determine how the user is scanning their environment. The system may recognize specific eye movement patterns associated with different activities. For example, reading typically involves left-to-right saccades with periodic return sweeps, while visual search tasks may show more scattered fixation patterns. The system may analyze pupil dilation responses to estimate cognitive load, with increased dilation often indicating higher mental effort. It may also examine microsaccade frequency and blink rate to assess fatigue or alertness levels.

These inferred states may then be used to provide context for the generative AI model, allowing it to produce more relevant and personalized outputs based on the user's current focus, task, and cognitive state. The system analyzes the user's eye movements to determine what type of activity they are engaged in. This process may involve identifying characteristic patterns in how the user visually interacts with their environment. For example, the sequence and pattern of fixations and saccades can indicate different types of tasks. For instance, reading typically involves left-to-right saccades with periodic return sweeps, while visual search tasks may show more scattered fixation patterns. Different tasks may be associated with distinct patterns of fixation duration and frequency. For example, longer fixations might indicate deeper processing or difficulty in comprehension.

The eye tracking system can use machine learning algorithms to classify eye movement patterns into predefined task categories, such as reading, visual search, or face recognition. The eye tracking system can also analyze the spatial and temporal characteristics of eye movements to infer more complex tasks, such as problem-solving or decision-making processes and combine eye movement data with contextual information from other sensors to improve task inference accuracy.

The system estimates the user's cognitive load, engagement level, or emotional state based on pupil diameter dynamics and other eye tracking metrics. The system analyzes various eye-related measurements to infer the user's mental and emotional state without requiring explicit input from the user. The eye tracking system may examine pupil diameter dynamics where changes in pupil size can indicate variations in cognitive load, emotional arousal, or interest level and blink rate and duration, which can be indicative of fatigue, cognitive load, or attentional states. The system can use pupil dilation responses to estimate cognitive load, with increased dilation often indicating higher mental effort. The system can analyze microsaccade frequency and characteristics to assess fatigue or alertness levels; employ machine learning algorithms to classify combinations of eye tracking metrics into different cognitive or emotional states; and integrate eye tracking data with other physiological measures (if available) to improve the accuracy of cognitive and emotional state estimation. This inferred cognitive state information can then be used to provide context for the generative AI model, allowing it to produce more relevant and personalized outputs based on the user's current mental and emotional state. The system can use saccade velocity and amplitude to determine variations in cognitive processing or emotional states. The eye tracking system merges the analyzed eye tracking data and inferred user state with additional data sources to create a comprehensive contextual input for the generative AI model. This integration may involve synthesizing information from multiple sources to create a more complete picture of the user's environment and state.

The eye tracking system may combine analyzed eye tracking data, such as processed information about the user's gaze patterns, fixations, and pupil dynamics; inferred user states: derived information about the user's focus, current task, cognitive load, and emotional state; camera images: visual information from the user's environment, captured by world-facing cameras on the AR device; audio input: sound data collected by microphones, which may include speech or environmental audio; and environmental sensor data: information about ambient conditions such as light levels, temperature, or motion. Namely, the eye tracking system may use computer vision algorithms to process camera images, identifying objects, text, or faces that correspond to the user's current visual focus as determined by eye tracking data. The eye tracking system may apply audio processing techniques to isolate and enhance relevant speech or sounds based on the user's inferred attention and task and correlate environmental sensor data with eye tracking and cognitive state information to provide context about the user's physical surroundings and how they interact with it. The eye tracking system creates a temporal map of the user's attention and environment, combining historical eye tracking data with changes in visual and auditory scenes over time and uses machine learning algorithms to identify patterns and relationships between different data sources, creating a unified representation of the user's context for input to the generative AI model.

In some examples, the eye tracking system preconditions data, such as by performing selective image blurring, including applying a Gaussian blur kernel to areas of images that are not the focus of the user's attention, while maintaining clarity in the ˜3° radial region surrounding the gaze vector. The eye tracking system can perform frame selection, choosing specific frames from a video stream based on the user's fixations, potentially reducing the number of frames processed from thousands to around 10 by focusing on fixation centroids and semantic mapping, creating a structured representation of the user's environment that highlights objects and areas most relevant to the user's current focus and task.

For example, the eye tracking system can apply dynamic blurring techniques that adjust the blur intensity based on the distance from the user's current fixation point, creating a foveal-like representation of the visual input. The eye tracking system can implement a temporal selection algorithm that not only chooses frames based on fixations but also considers the duration and sequence of fixations to capture the most informative moments in the visual stream. The eye tracking system provides computer vision algorithms to segment gazed objects and label elements in the visual field, creating a hierarchical semantic map that prioritizes objects based on their relevance to the user's inferred task and cognitive state and employ text extraction and optical character recognition (OCR) techniques when gaze dynamics indicate reading behavior, allowing the system to isolate and process text that the user has been focusing on. The eye tracking system adjusts the preconditioning parameters based on the inferred cognitive load or emotional state of the user, potentially simplifying inputs when high cognitive load is detected to avoid overwhelming the user with complex AI-generated outputs. This preconditioning process aims to distill the most relevant information from the combined data sources, tailoring the input to the generative AI model based on the user's current context, attention, and needs. By doing so, it enables the AI model to generate more targeted and contextually appropriate outputs.

In operation 720, routine 700 generates outputs from the generative AI model based on the preconditioned inputs and any explicit user input. Namely, the generative AI model produces outputs tailored to the user's inferred needs and intentions based on preconditioned inputs derived from eye tracking data and any explicit user input. The generative AI model synthesizes the preconditioned data to create contextually relevant outputs. These outputs may take various forms depending on the user's current task, focus, and cognitive state.

For example, the generative AI can produce image or video outputs based on the eye tracking data and user input, potentially using techniques like ControlNet to incorporate non-text inputs and generate text responses that are tailored to the user's current focus and inferred task, such as providing information about objects the user has been looking at. The generative AI can create audio outputs, such as speech translations or explanations, that are relevant to the user's current visual focus and environmental context.

In some cases, the generative AI can use the preconditioned image inputs to generate modified or enhanced versions of the user's visual field, such as adding virtual snow to a mountain range the user has been looking at. The generative AI can produce text explanations or translations of specific passages that the user has been reading, based on the gaze dynamics indicating reading behavior and generate contextually appropriate responses to user queries by considering not only the explicit input but also the user's recent visual focus, inferred cognitive state, and environmental factors. The generative AI can adjust the complexity or detail level of its outputs based on the user's inferred cognitive load or engagement level, as determined by pupil diameter dynamics and other eye tracking metrics. The generative AI can create semantic maps or inventories of objects in the user's environment, highlighting items that have been the focus of the user's attention.

This routine 700 may be initiated by powering on the AR device or launching a specific application.

The system employs several techniques to optimize data processing. As mentioned above, the eye tracking system performs selective image blurring, such as by applying Gaussian blur to areas outside the user's focus, reducing the amount of visual data that needs to be processed in detail. The disclosed system performs frame selection by choosing specific frames based on the user's fixations, which can reduce the number of frames processed from thousands to around 10 by focusing on the most relevant visual information. The eye tracking system includes a compression system. This component compresses temporal patterns of eye movements into higher-level features, further reducing the data volume while retaining essential information.

In some examples, the eye tracking system continuously monitors the user's gaze patterns and fixations. When the user focuses on a particular object or area in their environment, the data processing system analyzes this information in conjunction with camera input. The semantic segmentation model identifies and labels the object of interest. The integration system combines this data with any relevant environmental sensor information. The preconditioning system then prepares a focused input for the generative AI model, which generates contextually relevant information about the object. This information is displayed as an AR overlay through the AR device, providing the user with instant, gaze-activated information about their surroundings.

In some examples, the data processing system analyzes these metrics over time, while the compression system reduces the data to key features. The integration system combines this information with data about the current AR application state. Based on this integrated data, the preconditioning system prepares input for the generative AI model, which then generates recommendations for UI adjustments. These could include simplifying the interface when high cognitive load is detected, or expanding interactive elements in areas of frequent user focus.

In some examples, the camera captures the text, while the data processing system, in conjunction with the semantic segmentation model, isolates the text area. The integration system combines this with audio input from the microphone, potentially capturing spoken language as well. The preconditioning system prepares the isolated text and audio for the generative AI model, which performs real-time translation. The translated text or audio is then presented to the user through the AR device, with the system prioritizing the translation of text that the user is actively looking at.

In some examples, the data processing system combines environmental sensor data and audio input from the microphone. When the user initiates an interaction with the virtual assistant, the integration system provides a rich context based on the user's recent visual attention patterns and environmental cues. The preconditioning system prepares this contextual information for the generative AI model, allowing it to generate more relevant and anticipatory responses. For example, if the user has been looking at kitchen appliances, the assistant might proactively offer recipe suggestions or cooking tips.

In some examples, the data processing system analyzes these patterns over time, while the compression system identifies recurring features in the user's attention patterns. The integration system combines this data with information about the content being viewed. The preconditioning system prepares this integrated data for the generative AI model, which learns to predict what types of content the user finds most engaging or valuable. This model then guides the AR device in prioritizing and filtering content displayed to the user, creating a personalized information stream based on implicit attention cues. The data processing system analyzes fixation patterns and durations, while the semantic segmentation model identifies specific story elements that the user focuses on. The integration system combines this gaze data with the current story state. The preconditioning system then prepares input for the generative AI model, which dynamically adjusts the narrative based on the user's visual interests. For example, if the user pays particular attention to a specific character, the AI might expand that character's role in the story. The AR device then presents these personalized story elements, creating an interactive narrative that responds to the user's implicit choices.

### System with Head-Wearable Apparatus

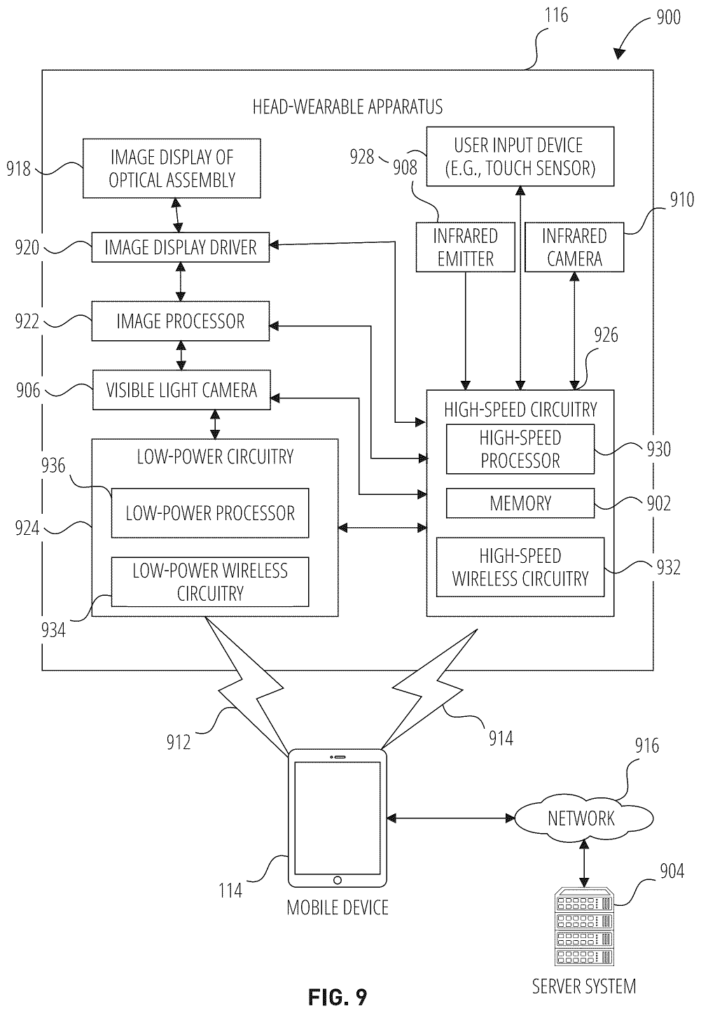

FIG. 9 illustrates a system 900 including a head-wearable apparatus 116 with a selector input device, according to some examples. FIG. 9 is a high-level functional block diagram of an example head-wearable apparatus 116 communicatively coupled to a mobile device 114 and various server systems 904 (e.g., the server system 110) via various network 916.

The head-wearable apparatus 116 includes one or more cameras, each of which may be, for example, a visible light camera 906, an infrared emitter 908, and an infrared camera 910.

The mobile device 114 connects with head-wearable apparatus 116 using both a low-power wireless connection 912 and a high-speed wireless connection 914. The mobile device 114 is also connected to the server system 904 and the network 916.

The head-wearable apparatus 116 further includes two image displays of the image display of optical assembly 918. The two image displays of optical assembly 918 include one associated with the left lateral side and one associated with the right lateral side of the head-wearable apparatus 116. The head-wearable apparatus 116 also includes an image display driver 920, an image processor 922, low-power circuitry 924, and high-speed circuitry 926. The image display of optical assembly 918 is for presenting images and videos, including an image that can include a graphical user interface to a user of the head-wearable apparatus 116.

The image display driver 920 commands and controls the image display of optical assembly 918. The image display driver 920 may deliver image data directly to the image display of optical assembly 918 for presentation or may convert the image data into a signal or data format suitable for delivery to the image display device. For example, the image data may be video data formatted according to compression formats, such as H.264 (MPEG-4 Part 10), HEVC, Theora, Dirac, RealVideo RV40, VP8, VP9, or the like, and still image data may be formatted according to compression formats such as Portable Network Group (PNG), Joint Photographic Experts Group (JPEG), Tagged Image File Format (TIFF) or exchangeable image file format (EXIF) or the like.

The head-wearable apparatus 116 includes a frame and stems (or temples) extending from a lateral side of the frame. The head-wearable apparatus 116 further includes a user input device 928 (e.g., touch sensor or push button), including an input surface on the head-wearable apparatus 116. The user input device 928 (e.g., touch sensor or push button) is to receive from the user an input selection to manipulate the graphical user interface of the presented image.

The components shown in FIG. 9 for the head-wearable apparatus 116 are located on one or more circuit boards, for example a PCB or flexible PCB, in the rims or temples. Alternatively, or additionally, the depicted components can be located in the chunks, frames, hinges, or bridge of the head-wearable apparatus 116. Left and right visible light cameras 906 can include digital camera elements such as a complementary metal oxide-semiconductor (CMOS) image sensor, charge-coupled device, camera lenses, or any other respective visible or light-capturing elements that may be used to capture data, including images of scenes with unknown objects.

The head-wearable apparatus 116 includes a memory 902, which stores instructions to perform a subset, or all the functions described herein. The memory 902 can also include storage device.

As shown in FIG. 9, the high-speed circuitry 926 includes a high-speed processor 930, a memory 902, and high-speed wireless circuitry 932. In some examples, the image display driver 920 is coupled to the high-speed circuitry 926 and operated by the high-speed processor 930 to drive the left and right image displays of the image display of optical assembly 918. The high-speed processor 930 may be any processor capable of managing high-speed communications and operation of any general computing system needed for the head-wearable apparatus 116. The high-speed processor 930 includes processing resources needed for managing high-speed data transfers on a high-speed wireless connection 914 to a wireless local area network (WLAN) using the high-speed wireless circuitry 932. In certain examples, the high-speed processor 930 executes an operating system such as a LINUX operating system or other such operating system of the head-wearable apparatus 116, and the operating system is stored in the memory 902 for execution. In addition to any other responsibilities, the high-speed processor 930 executing a software architecture for the head-wearable apparatus 116 is used to manage data transfers with high-speed wireless circuitry 932. In certain examples, the high-speed wireless circuitry 932 is configured to implement Institute of Electrical and Electronic Engineers (IEEE) 802.11 communication standards, also referred to herein as WI-FI®. In some examples, other high-speed communications standards may be implemented by the high-speed wireless circuitry 932.

The low-power wireless circuitry 934 and the high-speed wireless circuitry 932 of the head-wearable apparatus 116 can include short-range transceivers (e.g., Bluetooth™, Bluetooth LE, Zigbee, ANT+) and wireless wide, local, or wide area Network transceivers (e.g., cellular or WI-FI®). Mobile device 114, including the transceivers communicating via the low-power wireless connection 912 and the high-speed wireless connection 914, may be implemented using details of the architecture of the head-wearable apparatus 116, as can other elements of the Network 916.

The memory 902 includes any storage device capable of storing various data and applications, including, among other things, camera data generated by the left and right visible light cameras 906, the infrared camera 910, and the image processor 922, as well as images generated for display by the image display driver 920 on the image displays of the image display of optical assembly 918. While the memory 902 is shown as integrated with high-speed circuitry 926, in some examples, the memory 902 may be an independent standalone element of the head-wearable apparatus 116. In certain such examples, electrical routing lines may provide a connection through a chip that includes the high-speed processor 930 from the image processor 922 or the low-power processor 936 to the memory 902. In some examples, the high-speed processor 930 may manage addressing of the memory 902 such that the low-power processor 936 will boot the high-speed processor 930 any time that a read or write operation involving memory 902 is needed.

As shown in FIG. 9, the low-power processor 936 or high-speed processor 930 of the head-wearable apparatus 116 can be coupled to the camera (visible light camera 906, infrared emitter 908, or infrared camera 910), the image display driver 920, the user input device 928 (e.g., touch sensor or push button), and the memory 902.

The head-wearable apparatus 116 is connected to a host computer. For example, the head-wearable apparatus 116 is paired with the mobile device 114 via the high-speed wireless connection 914 or connected to the server system 904 via the network 916. The server system 904 may be one or more computing devices as part of a service or network computing system, for example, that includes a processor, a memory, and network communication interface to communicate over the Network 916 with the mobile device 114 and the head-wearable apparatus 116.

The mobile device 114 includes a processor and a network communication interface coupled to the processor. The network communication interface allows for communication over the network 916, low-power wireless connection 912, or high-speed wireless connection 914. Mobile device 114 can further store at least portions of the instructions in the memory of the mobile device 114 memory to implement the functionality described herein.

Output components of the head-wearable apparatus 116 include visual components, such as a display such as a liquid crystal display (LCD), a plasma display panel (PDP), a light-emitting diode (LED) display, a projector, or a waveguide. The image displays of the optical assembly are driven by the image display driver 920. The output components of the head-wearable apparatus 116 further include acoustic components (e.g., speakers), haptic components (e.g., a vibratory motor), other signal generators, and so forth. The input components of the head-wearable apparatus 116, the mobile device 114, and server system 904, such as the user input device 928, may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

The head-wearable apparatus 116 may also include additional peripheral device elements. Such peripheral device elements may include sensors and display elements integrated with the head-wearable apparatus 116. For example, peripheral device elements may include any input/outpu (I/O) components including output components, motion components, position components, or any other such elements described herein.

In some examples, the head-wearable apparatus 116 may include biometric components or sensors s to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The biometric components may include a brain-machine interface (BMI) system that allows communication between the brain and an external device or machine. This may be achieved by recording brain activity data, translating this data into a format that can be understood by a computer, and then using the resulting signals to control the device or machine.

Example types of BMI technologies, including:
Electroencephalography (EEG) based BMIs, which record electrical activity in the brain using electrodes placed on the scalp.
Invasive BMIs, which uses electrodes that are surgically implanted into the brain.
Optogenetics BMIs, which use light to control the activity of specific nerve cells in the brain.

Any biometric data collected by the biometric components is captured and stored with only user approval and deleted on user request, and in accordance with applicable laws. Further, such biometric data may be used for very limited purposes, such as identification verification. To ensure limited and authorized use of biometric information and other personally identifiable information (PII), access to this data is restricted to authorized personnel only, if at all. Any use of biometric data may strictly be limited to identification verification purposes, and the biometric data is not shared or sold to any third party without the explicit consent of the user. In addition, appropriate technical and organizational measures are implemented to ensure the security and confidentiality of this sensitive information.

The motion components include acceleration sensor components (e.g., accelerometer), gravitation sensor components, rotation sensor components (e.g., gyroscope), and so forth. The position components include location sensor components to generate location coordinates (e.g., a Global Positioning System (GPS) receiver component), Wi-Fi or Bluetooth™ transceivers to generate positioning system coordinates, altitude sensor components (e.g., altimeters or barometers that detect air pressure from which altitude may be derived), orientation sensor components (e.g., magnetometers), and the like. Such positioning system coordinates can also be received over low-power wireless connections 912 and high-speed wireless connection 914 from the mobile device 114 via the low-power wireless circuitry 934 or high-speed wireless circuitry 932.

### Machine Architecture

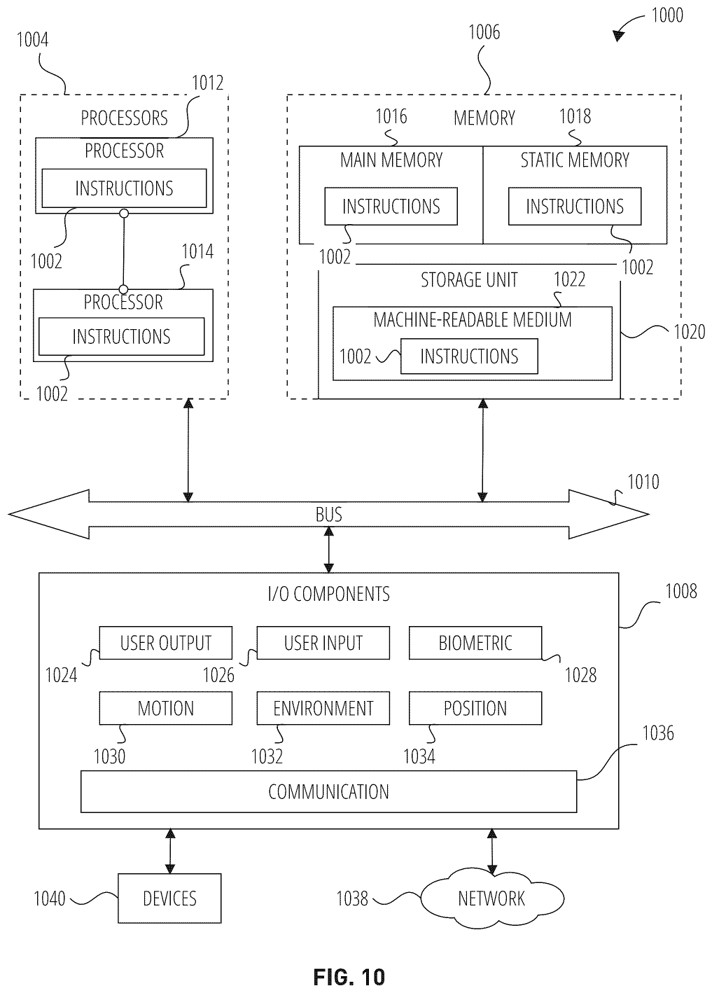

FIG. 10 is a diagrammatic representation of the machine 1000 within which instructions 1002 (e.g., software, a program, an application, an applet, an app, or other executable code) for causing the machine 1000 to perform any one or more of the methodologies discussed herein may be executed. For example, the instructions 1002 may cause the machine 1000 to execute any one or more of the methods described herein. The instructions 1002 transform the general, non-programmed machine 1000 into a particular machine 1000 programmed to carry out the described and illustrated functions in the manner described. The machine 1000 may operate as a standalone device or may be coupled (e.g., networked) to other machines. In a networked deployment, the machine 1000 may operate in the capacity of a server machine or a client machine in a server-client network environment, or as a peer machine in a peer-to-peer (or distributed) network environment. The machine 1000 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 1002, sequentially or otherwise, that specify actions to be taken by the machine 1000. Further, while a single machine 1000 is illustrated, the term “machine” shall also be taken to include a collection of machines that individually or jointly execute the instructions 1002 to perform any one or more of the methodologies discussed herein. The machine 1000, for example, may comprise the user system 102 or any one of multiple server devices forming part of the server system 110. In some examples, the machine 1000 may also comprise both client and server systems, with certain operations of a particular method or algorithm being performed on the server-side and with certain operations of the method or algorithm being performed on the client-side.

The machine 1000 may include processors 1004, memory 1006, and input/output I/O components 1008, which may be configured to communicate with each other via a bus 1010.

The memory 1006 includes a main memory 1016, a static memory 1018, and a storage unit 1020, both accessible to the processors 1004 (or processor 1014 and processor 1012) via the bus 1010. The main memory 1006, the static memory 1018, and storage unit 1020 store the instructions 1002 embodying any one or more of the methodologies or functions described herein. The instructions 1002 may also reside, completely or partially, within the main memory 1016, within the static memory 1018, within machine-readable medium 1022 within the storage unit 1020, within at least one of the processors 1004 (e.g., within the processor's cache memory), or any suitable combination thereof, during execution thereof by the machine 1000.

The I/O components 1008 may include a wide variety of components to receive input, provide output, produce output, transmit information, exchange information, capture measurements, and so on. The specific I/O components 1008 that are included in a particular machine will depend on the type of machine. For example, portable machines such as mobile phones may include a touch input device or other such input mechanisms, while a headless server machine will likely not include such a touch input device. It will be appreciated that the I/O components 1008 may include many other components that are not shown in FIG. 10. In various examples, the I/O components 1008 may include user output components 1024 and user input components 1026. The user output components 1024 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 1026 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 1008 may include biometric components 1028, motion components 1030, environmental components 1032, or position components 1034, among a wide array of other components. For example, the biometric components 1028 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The biometric components may include a brain-machine interface (BMI) system that allows communication between the brain and an external device or machine. This may be achieved by recording brain activity data, translating this data into a format that can be understood by a computer, and then using the resulting signals to control the device or machine.

Example types of BMI technologies, including:
Electroencephalography (EEG) based BMIs, which record electrical activity in the brain using electrodes placed on the scalp.
Invasive BMIs, which used electrodes that are surgically implanted into the brain.
Optogenetics BMIs, which use light to control the activity of specific nerve cells in the brain.

Any biometric data collected by the biometric components is captured and stored only with user approval and deleted on user request, and in accordance with applicable laws. Further, such biometric data may be used for very limited purposes, such as identification verification. To ensure limited and authorized use of biometric information and other personally identifiable information (PII), access to this data is restricted to authorized personnel only, if at all. Any use of biometric data may strictly be limited to identification verification purposes, and the data is not shared or sold to any third party without the explicit consent of the user. In addition, appropriate technical and organizational measures are implemented to ensure the security and confidentiality of this sensitive information.

The motion components 1030 include acceleration sensor components (e.g., accelerometer), gravitation sensor components, rotation sensor components (e.g., gyroscope).

The environmental components 1032 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the user system 102 may have a camera system comprising, for example, front cameras on a front surface of the user system 102 and rear cameras on a rear surface of the user system 102. The front cameras may, for example, be used to capture still images and video of a user of the user system 102 (e.g., “selfies”), which may then be modified with digital effect data (e.g., filters) described above. The rear cameras may, for example, be used to capture still images and videos in a more traditional camera mode, with these images similarly being modified with digital effect data. In addition to front and rear cameras, the user system 102 may also include a 360° camera for capturing 360° photographs and videos.

Moreover, the camera system of the user system 102 may be equipped with advanced multi-camera configurations. This may include dual rear cameras, which might consist of a primary camera for general photography and a depth-sensing camera for capturing detailed depth information in a scene. This depth information can be used for various purposes, such as creating a bokeh effect in portrait mode, where the subject is in sharp focus while the background is blurred. In addition to dual camera setups, the user system 102 may also feature triple, quad, or even penta camera configurations on both the front and rear sides of the user system 102. These multiple cameras systems may include a wide camera, an ultra-wide camera, a telephoto camera, a macro camera, and a depth sensor, for example.

Communication may be implemented using a wide variety of technologies. The I/O components 1008 further include communication components 1036 operable to couple the machine 1000 to a Network 1038 or devices 1040 via respective coupling or connections. For example, the communication components 1036 may include a network interface component or another suitable device to interface with the Network 1038. In further examples, the communication components 1036 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1040 may be another machine or any of a wide variety of peripheral devices (e.g., a peripheral device coupled via a USB).

Moreover, the communication components 1036 may detect identifiers or include components operable to detect identifiers. For example, the communication components 1036 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the communication components 1036, such as location via Internet Protocol (IP) geolocation, location via Wi-Fi® signal triangulation, location via detecting an NFC beacon signal that may indicate a particular location, and so forth.

The various memories (e.g., main memory 1016, static memory 1018, and memory of the processors 1004) and storage unit 1020 may store one or more sets of instructions and data structures (e.g., software) embodying or used by any one or more of the methodologies or functions described herein. These instructions (e.g., the instructions 1002), when executed by processors 1004, cause various operations to implement the disclosed examples.

The instructions 1002 may be transmitted or received over the Network 1038, using a transmission medium, via a network interface device (e.g., a network interface component included in the communication components 1036) and using any one of several well-known transfer protocols (e.g., hypertext transfer protocol (HTTP)). Similarly, the instructions 1002 may be transmitted or received using a transmission medium via a coupling (e.g., a peer-to-peer coupling) to the devices 1040.

### Software Architecture

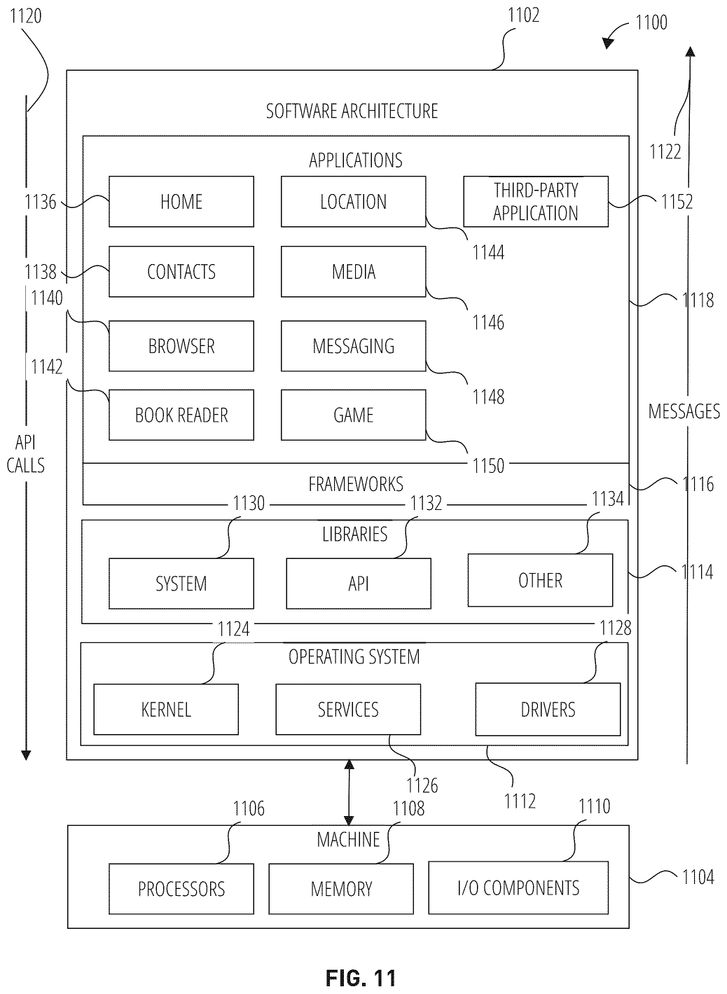

FIG. 11 is a block diagram 1100 illustrating a software architecture 1102, which can be installed on any one or more of the devices described herein. The software architecture 1102 is supported by hardware such as a machine 1104 that includes processors 1106, memory 1108, and I/O components 1110. In this example, the software architecture 1102 can be conceptualized as a stack of layers, where each layer provides a particular functionality. The software architecture 1102 includes layers such as an operating system 1112, libraries 1114, frameworks 1116, and applications 1118. Operationally, the applications 1118 invoke API calls 1120 through the software stack and receive messages 1122 in response to the API calls 1120.

The operating system 1112 manages hardware resources and provides common services. The operating system 1112 includes, for example, a kernel 1124, services 1126, and drivers 1128. The kernel 1124 acts as an abstraction layer between the hardware and the other software layers. For example, the kernel 1124 provides memory management, processor management (e.g., scheduling), component management, networking, and security settings, among other functionalities. The services 1126 can provide other common services for the other software layers. The drivers 1128 are responsible for controlling or interfacing with the underlying hardware. For instance, the drivers 1128 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 1114 provide a common low-level infrastructure used by the applications 1118. The libraries 1114 can include system libraries 1130 (e.g., C standard library) that provide functions such as memory allocation functions, string manipulation functions, mathematical functions, and the like. In addition, the libraries 1114 can include API libraries 1132 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1114 can also include a wide variety of other libraries 1134 to provide many other APIs to the applications 1118.

The frameworks 1116 provide a common high-level infrastructure that is used by the applications 1118. For example, the frameworks 1116 provide various graphical user interface (GUI) functions, high-level resource management, and high-level location services. The frameworks 1116 can provide a broad spectrum of other APIs that can be used by the applications 1118, some of which may be specific to a particular operating system or platform.

In an example, the applications 1118 may include a home application 1136, a contacts application 1138, a browser application 1140, a book reader application 1142, a location application 1144, a media application 1146, a messaging application 1148, a game application 1150, and a broad assortment of other applications such as a third-party application 1152. The applications 1118 are programs that execute functions defined in the programs. Various programming languages can be employed to create one or more of the applications 1118, structured in a variety of manners, such as object-oriented programming languages (e.g., Objective-C, Java, or C++) or procedural programming languages (e.g., C or assembly language). In a specific example, the third-party application 1152 (e.g., an application developed using the ANDROID™ or IOS™ software development kit (SDK) by an entity other than the vendor of a platform) may be mobile software running on a mobile operating system such as IOS™, ANDROID™, WINDOWS® Phone, or another mobile operating system. In this example, the third-party application 1152 can invoke the API calls 1120 provided by the operating system 1112 to facilitate functionalities described herein.

As used in this disclosure, phrases of the form “at least one of an A, a B, or a C,” “at least one of A, B, or C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

Unless the context clearly requires otherwise, throughout the description and the claims, the words “comprise,” “comprising,” and the like are to be construed in an inclusive sense, as opposed to an exclusive or exhaustive sense, e.g., in the sense of “including, but not limited to.”

As used herein, the terms “connected,” “coupled,” or any variant thereof means any connection or coupling, either direct or indirect, between two or more elements; the coupling or connection between the elements can be physical, logical, or a combination thereof.

Additionally, the words “herein,” “above,” “below,” and words of similar import, when used in this application, refer to this application as a whole and not to any portions of this application. Where the context permits, words using the singular or plural number may also include the plural or singular number respectively.

The word “or” in reference to a list of two or more items covers all the following interpretations of the word: any one of the items in the list, all the items in the list, and any combination of the items in the list. Likewise, the term “and/or” in reference to a list of two or more items covers all the following interpretations of the word: any one of the items in the list, all the items in the list, and any combination of the items in the list.

The various features, operations, or processes described herein may be used independently of one another, or may be combined in various ways. All possible combinations and sub-combinations are intended to fall within the scope of this disclosure. In addition, certain method or process blocks may be omitted in some implementations.

Although some examples, e.g., those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence.

### EXAMPLE STATEMENTS

Example 1. A system comprising: at least one processor; at least one memory component storing instructions that, when executed by the at least one processor, cause the at least one processor to perform operations comprising: accessing eye gaze information associated with a field of view of a head-wearable apparatus; generating contextual information associated with the field of view of the head-wearable apparatus based on the eye gaze information; processing, by a generative machine learning model, the contextual information and content associated with the field of view of the head-wearable apparatus to generate an output; and presenting on a display of the head-wearable apparatus the output generated by the generative machine learning model.

Example 2. The system of Example 1, wherein the generative machine learning model comprises one or more large language models (LLMs) and wherein the content associated with the field comprises at least one of an image of the field of view, scene descriptor, or voice input.

Example 3. The system of any one of Examples 1-2, wherein the operations comprise: obtaining, as the eye gaze information, a gaze vector, a vergence angle, and a pupil diameter associated with an eye of a user wearing the head-wearable apparatus; and processing the eye gaze information to infer at least one of attention information, task information or a cognitive state using fixation information of the eye and saccade of the eye, the fixation information representing intervals at which the eye is stable and the saccade of the eye representing intervals at which the eye moves at a rate faster than a threshold rate.

Example 4. The system of any one of Examples 1-3, wherein the operations comprise: determining that the contextual information indicates that a user of the head-wearable apparatus is reading text visible in the field of view; and in response to determining that the contextual information indicates that the user of the head-wearable apparatus is reading the text visible in the field of view, generating a prompt with an instruction for the generative machine learning model to process the text that is visible in the field of view and disregard other objects in the same field of view.

Example 5. The system of Example 4, wherein the operations comprise: capturing an image of the field of view comprising the text, wherein the prompt further instructs the generative machine learning model to perform optical character recognition on the text in the image to convert the image of the text into optical characters and to generate, as the output, content related to the text that is in the image.

Example 6. The system of Example 5, wherein the operations comprise: determining that the text in the image comprises a threshold number of passages; and using the contextual information to select a particular passage as the text while excluding text present in other passages in the image.

Example 7. The system of any one of Examples 5-6, wherein the operations comprise: determining that the contextual information indicates that a portion of the text has been read by the user multiple times at least based on regressive saccades; in response to determining that the contextual information indicates that the portion of the text has been read by the user multiple times, determining that the user is having comprehension difficulties and providing information indicating that the user is having comprehension difficulties to the generative machine learning model, the output of the generative machine learning model being generated by associating a greater weight with the portion of the text over other portions of the text.

Example 8. The system of any one of Examples 1-7, wherein the operations comprise: determining that the contextual information indicates that a user of the head-wearable apparatus is focusing on different portions of a first object that is visible in the field of view, the first object being one of a plurality of objects in the field of view; and in response to determining that the contextual information indicates that the user of the head-wearable apparatus is focusing on the different portions of the first object that is visible in the field of view, generating a prompt with an instruction for the generative machine learning model to generate content based on the different portions.

Example 9. The system of Example 8, wherein the operations comprise: determining spatiotemporal dynamics associated with the different portions; and providing the spatiotemporal dynamics to the generative machine learning model to generate the content, the spatiotemporal dynamics indicating which of the different portions of the first object the user is focusing on over time.

Example 10. The system of any one of Examples 8-9, wherein the operations comprise: receiving a voice command from the user requesting a modification to the first object that is visible in the field of view; modifying the prompt to include an image of the first object that is visible in the field of view and the modification to the first object; and generating, by the generative machine learning model, a new image that includes the modification to the different portions of the first object, the generative machine learning model selecting to apply the modification to a first portion of the first object and not a second portion of the first object based on the contextual information that indicates that the user of the head-wearable apparatus is focusing on the first portion of the first object.

Example 11. The system of Example 10, wherein the operations comprise: determining that the user of the head-wearable apparatus is focusing on the first portion of the first object; cropping the image of the first object to depict the first portion of the first object; and providing, as part of the prompt, the cropped image that depicts the first portion of the first object.

Example 12. The system of Example 11, wherein the operations comprise: continuously recording video of the field of view of the head-wearable apparatus in a video buffer having a specified size to represent images seen within a past threshold interval, wherein each time point in the video includes information that indicates gaze of the user; in response to receiving the voice command, obtaining a specified set of frames from the video that were captured within a specified interval prior to when the voice command was received; applying a Gaussian blur kernel to the specified set of frames to regions depicted in the specified set of frames that exceed the gaze of the user by more than a specified threshold; and providing one or more of the specified set of frames to which the Gaussian blur kernel was applied to the cropped image.

Example 13. The system of Example 12, wherein the operations comprise: discarding one or more frames of the video that fail to satisfy a fixation parameter of the eye; and aligning a remaining set of frames of the video that have not been discarded.

Example 14. The system of any one of Examples 1-13, wherein the operations comprise: continuously recording video of the field of view of the head-wearable apparatus in a video buffer having a specified size to represent images seen within a past threshold interval, wherein each time point in the video includes information that indicates gaze of a user; determining that, in an individual frame of the video, gaze directed at a particular object in the individual frame satisfies a fixation parameter; in response to determining that, in the individual frame of the video, the gaze directed at the particular object in the individual frame satisfies the fixation parameter, processing the frame by the generative machine learning model to segment the particular object; adding the segmented particular object to an inventory of objects, the inventory of objects being used by the generative machine learning model to respond to one or more queries received from the user.

Example 15. The system of Example 14, wherein the operations comprise: classifying each object in the inventory of objects; determining that a threshold number of objects in the inventory of objects is associated with a same classification; and in response to determining that the threshold number of objects in the inventory of objects is associated with the same classification, automatically presenting information associated with the threshold number of objects on the head-wearable apparatus.

Example 16. The system of any one of Examples 1-15, wherein the operations comprise: determining that the contextual information indicates that a user of the head-wearable apparatus is associated with a cognitive load that transgresses a threshold based on pupil diameter dynamics of the user; and in response to determining that the contextual information indicates that the user of the head-wearable apparatus is associated with the cognitive load that transgresses the threshold, reducing a quantity of visual notifications provided to the user on the head-wearable apparatus.

Example 17. The system of any one of Examples 1-16, wherein the operations comprise: obtaining an audio stream comprising multiple speakers; and processing the audio stream with an image of the field of view by the generative machine learning model along with the contextual information to select a particular portion of the audio stream corresponding to one of the multiple speakers depicted in the image.

Example 18. The system of Example 17, wherein the operations comprise: filtering the particular portion of the audio stream to exclude audio associated with other speakers of the multiple speakers; and translating words in the particular portion of the audio stream as the output.

Example 19. A method for enhancing generative AI outputs using eye tracking data, comprising: collecting eye tracking data from a user over a predetermined time period; analyzing the collected eye tracking data to infer at least one of: user focus, task, cognitive state, or emotional state; combining the analyzed eye tracking data with at least one additional data source; preconditioning inputs to a generative AI model based on the combined data; and generating outputs from the generative AI model based on the preconditioned inputs and any explicit user input.

Example 20. The method of Example 19, wherein collecting eye tracking data comprises measuring at least one of: gaze vector, vergence angle, pupil diameter, fixations, or saccades.

Example 21. The method of any one of Examples 19-20, wherein the predetermined time period includes at least one second of historical data.

Example 22. The method of any one of Examples 19-21, wherein the additional data source comprises at least one of: camera images, audio input, or environmental sensor data.

Example 23. The method of any one of Examples 19-22, wherein preconditioning inputs comprises at least one of: applying selective image blurring, selecting frames based on fixations, or emphasizing areas of visual interest.

Example 24. The method any one of Examples 19-23, further comprising continuously recording eye movements during device operation.

Example 25. The method of any one of Examples 19-24, further comprising predicting the origination of speech in crowded environments using the eye tracking data.

Example 26. The method of any one of Examples 19-25, further comprising building an inventory of objects based on user fixations and semantic segmentation of camera images.

Example 27. The method of any one of Examples 19-26, wherein generating outputs comprises producing image or video outputs based on the eye tracking data and user input.

Example 28. The method of any one of Examples 19-27, further comprising extracting and processing text based on gaze dynamics indicating reading behavior.

Example 29. The method of any one of Examples 19-28, wherein the method is performed by an augmented reality (AR) device.

Example 30. The method of any one of Examples 19-29, further comprising analyzing pupil diameter dynamics to estimate cognitive load, engagement, or emotional states.

Example 31. The method of any one of Examples 19-30, further comprising adjusting the generative AI model outputs based on inferred comprehension difficulties derived from the eye tracking data.

Example 32. The method of any one of Examples 19-31, wherein analyzing the collected eye tracking data comprises identifying patterns and trends in user attention over time.

Example 33. The method of any one of Examples 19-32, further comprising compressing temporal patterns of eye movements into higher-level features for input to the generative AI model.

Example 34. The method of any one of Examples 19-33, wherein preconditioning inputs comprises creating a semantic map of the user's environment based on the eye tracking data and camera images.

Example 35 is an apparatus comprising means to implement of any of the above Examples.

### Term Examples

“Gaze vector” may include a vector that indicates a direction to which a pupil is pointing or directed. The gaze vector can be a mathematical representation of the direction in which a person's eyes are looking. It can be described as a three-dimensional vector originating from the center of the eye and pointing in the direction of the person's gaze.

“Carrier signal” may include, for example, any intangible medium that can store, encoding, or carrying instructions for execution by the machine and includes digital or analog communications signals or other intangible media to facilitate communication of such instructions. Instructions may be transmitted or received over a network using a transmission medium via a network interface device.

“Client device” may include, for example, any machine that interfaces to a network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Component” may include, for example, a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component”(or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” may refer to a hardware component implemented using one or more processors. Similarly, the methods described herein may be at least partially Processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” may include, for example, both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Machine storage medium” may include, for example, a single or multiple storage devices and media (e.g., a centralized or distributed database, and associated caches and servers) that store executable instructions, routines, and data. The term shall accordingly be taken to include, but not be limited to, solid-state memories, and optical and magnetic media, including memory internal or external to processors. Specific examples of machine-storage media, computer-storage media, and device-storage media include non-volatile memory, including by way of example semiconductor memory devices, e.g., erasable programmable read-only memory (EPROM), electrically erasable programmable read-only memory (EEPROM), Field-Programmable Gate Arrays (FPGA), flash memory devices, Solid State Drives (SSD), and Non-Volatile Memory Express (NVMe) devices; magnetic disks such as internal hard disks and removable disks; magneto-optical disks; and CD-ROM, DVD-ROM, Blu-ray Discs, and Ultra HD Blu-ray discs. In addition, machine storage medium may also refer to cloud storage services, Network Attached Storage (NAS), Storage Area Networks (SAN), and object storage devices. The terms “machine-storage medium,” “device-storage medium,” and “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Network” may include, for example, one or more portions of a network that may be an ad hoc network, an intranet, an extranet, a Virtual Private Network (VPN), a Local Area Network (LAN), a Wireless LAN (WLAN), a Wide Area Network (WAN), a Wireless WAN (WWAN), a Metropolitan Area Network (MAN), the Internet, a portion of the Internet, a portion of the Public Switched Telephone Network (PSTN), a Voice over IP (VoIP) network, a cellular telephone network, a 5G™ network, a wireless network, a Wi-Fi® network, a Wi-Fi 6® network, a Li-Fi network, a Zigbee® network, a Bluetooth® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as third Generation Partnership Project (3GPP) including 4G, fifth-generation wireless (5G) networks, Universal Mobile Telecommunications System (UMTS), High Speed Packet Access (HSPA), Long Term Evolution (LTE) standard, others defined by various standard-setting organizations, other long-range protocols, or other data transfer technology.

“Non-transitory computer-readable storage medium” may include, for example, a tangible medium that is capable of storing, encoding, or carrying the instructions for execution by a machine.

“Processor” may include, for example, data processors such as a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), a Quantum Processing Unit (QPU), a Tensor Processing Unit (TPU), a Neural Processing Unit (NPU), a Field Programmable Gate Array (FPGA), another processor, or any suitable combination thereof. The term “processor” may include multi-core processors that may comprise two or more independent processors (sometimes referred to as “cores”) that may execute instructions contemporaneously. These cores can be homogeneous (e.g., all cores are identical, as in multicore CPUs) or heterogeneous (e.g., cores are not identical, as in many modern GPUs and some CPUs). In addition, the term “processor” may also encompass systems with a distributed architecture, where multiple processors are interconnected to perform tasks in a coordinated manner. This includes cluster computing, grid computing, and cloud computing infrastructures. Furthermore, the processor may be embedded in a device to control specific functions of that device, such as in an embedded system, or it may be part of a larger system, such as a server in a data center. The processor may also be virtualized in a software-defined infrastructure, where the processor's functions are emulated in software.

“Signal medium” may include, for example, an intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

“User device” may include, for example, a device accessed, controlled or owned by a user and with which the user interacts perform an action, engagement or interaction on the user device, including an interaction with other users or computer systems.

What is claimed is:

1. A system comprising:
at least one processor;
at least one memory component storing instructions that, when executed by the at least one processor, cause the at least one processor to perform operations comprising:
accessing eye gaze information associated with a field of view of a head-wearable apparatus;
generating contextual information associated with the field of view of the head-wearable apparatus based on the eye gaze information;
processing, by a generative machine learning model, the contextual information and content associated with the field of view of the head-wearable apparatus to generate an output; and
presenting on a display of the head-wearable apparatus the output generated by the generative machine learning model.

2. The system of claim 1, wherein the generative machine learning model comprises one or more large language models (LLMs), and wherein the content associated with the field comprises at least one of an image of the field of view, scene descriptor, or voice input.

3. The system of claim 1, wherein the operations comprise:
obtaining, as the eye gaze information, a gaze vector, a vergence angle, and a pupil diameter associated with an eye of a user wearing the head-wearable apparatus; and
processing the eye gaze information to infer at least one of attention information, task information, or a cognitive state using fixation information of the eye and saccade of the eye, the fixation information representing intervals at which the eye is stable and the saccade of the eye representing intervals at which the eye moves at a rate faster than a threshold rate.

4. The system of claim 1, wherein the operations comprise:
determining that the contextual information indicates that a user of the head-wearable apparatus is reading text visible in the field of view; and
in response to determining that the contextual information indicates that the user of the head-wearable apparatus is reading the text visible in the field of view, generating a prompt with an instruction for the generative machine learning model to process the text that is visible in the field of view and disregard other objects in the same field of view.

5. The system of claim 4, wherein the operations comprise:
capturing an image of the field of view comprising the text, wherein the prompt further instructs the generative machine learning model to perform optical character recognition on the text in the image to convert the image of the text into optical characters and to generate, as the output, content related to the text that is in the image.

6. The system of claim 5, wherein the operations comprise:
determining that the text in the image comprises a threshold number of passages; and
using the contextual information to select a particular passage as the text while excluding text present in other passages in the image.

7. The system of claim 5, wherein the operations comprise:
determining that the contextual information indicates that a portion of the text has been read by the user multiple times at least based on regressive saccades; and
in response to determining that the contextual information indicates that the portion of the text has been read by the user multiple times, determining that the user is having comprehension difficulties and providing information indicating that the user is having comprehension difficulties to the generative machine learning model, the output of the generative machine learning model being generated by associating a greater weight with the portion of the text over other portions of the text.

8. The system of claim 1, wherein the operations comprise:
determining that the contextual information indicates that a user of the head-wearable apparatus is focusing on different portions of a first object that is visible in the field of view, the first object being one of a plurality of objects in the field of view; and
in response to determining that the contextual information indicates that the user of the head-wearable apparatus is focusing on the different portions of the first object that is visible in the field of view, generating a prompt with an instruction for the generative machine learning model to generate content based on the different portions.

9. The system of claim 8, wherein the operations comprise:
determining spatiotemporal dynamics associated with the different portions; and
providing the spatiotemporal dynamics to the generative machine learning model to generate the content, the spatiotemporal dynamics indicating which of the different portions of the first object the user is focusing on over time.

10. The system of claim 8, wherein the operations comprise:
receiving a voice command from the user requesting a modification to the first object that is visible in the field of view;
modifying the prompt to include an image of the first object that is visible in the field of view and the modification to the first object; and
generating, by the generative machine learning model, a new image that includes the modification to the different portions of the first object, the generative machine learning model selecting to apply the modification to a first portion of the first object and not a second portion of the first object based on the contextual information that indicates that the user of the head-wearable apparatus is focusing on the first portion of the first object.

11. The system of claim 10, wherein the operations comprise:
determining that the user of the head-wearable apparatus is focusing on the first portion of the first object;
cropping the image of the first object to depict the first portion of the first object; and
providing, as part of the prompt, the cropped image that depicts the first portion of the first object.

12. The system of claim 11, wherein the operations comprise:
continuously recording video of the field of view of the head-wearable apparatus in a video buffer having a specified size to represent images seen within a past threshold interval, wherein each time point in the video includes information that indicates gaze of the user;
in response to receiving the voice command, obtaining a specified set of frames from the video that were captured within a specified interval prior to when the voice command was received;
applying a Gaussian blur kernel to the specified set of frames to regions depicted in the specified set of frames that exceed the gaze of the user by more than a specified threshold; and
providing one or more of the specified set of frames to which the Gaussian blur kernel was applied to the cropped image.

13. The system of claim 12, wherein the operations comprise:
discarding one or more frames of the video that fail to satisfy a fixation parameter of the eye; and
aligning a remaining set of frames of the video that have not been discarded.

14. The system of claim 1, wherein the operations comprise:
continuously recording video of the field of view of the head-wearable apparatus in a video buffer having a specified size to represent images seen within a past threshold interval, wherein each time point in the video includes information that indicates gaze of a user;
determining that, in an individual frame of the video, gaze directed at a particular object in the individual frame satisfies a fixation parameter;
in response to determining that, in the individual frame of the video, the gaze directed at the particular object in the individual frame satisfies the fixation parameter, processing the frame by the generative machine learning model to segment the particular object; and
adding the segmented particular object to an inventory of objects, the inventory of objects being used by the generative machine learning model to respond to one or more queries received from the user.

15. The system of claim 14, wherein the operations comprise:
classifying each object in the inventory of objects;
determining that a threshold number of objects in the inventory of objects is associated with a same classification; and
in response to determining that the threshold number of objects in the inventory of objects is associated with the same classification, automatically presenting information associated with the threshold number of objects on the head-wearable apparatus.

16. The system of claim 1, wherein the operations comprise:
determining that the contextual information indicates that a user of the head-wearable apparatus is associated with a cognitive load that transgresses a threshold based on pupil diameter dynamics of the user; and
in response to determining that the contextual information indicates that the user of the head-wearable apparatus is associated with the cognitive load that transgresses the threshold, reducing a quantity of visual notifications provided to the user on the head-wearable apparatus.

17. The system of claim 1, wherein the operations comprise:
obtaining an audio stream comprising multiple speakers; and
processing the audio stream with an image of the field of view by the generative machine learning model along with the contextual information to select a particular portion of the audio stream corresponding to one of the multiple speakers depicted in the image.

18. The system of claim 17, wherein the operations comprise:
processing the particular portion of the audio stream to exclude audio associated with other speakers of the multiple speakers; and
translating words in the particular portion of the audio stream as the output.

19. A computer-implemented method comprising:
accessing eye gaze information associated with a field of view of a head-wearable apparatus;
generating contextual information associated with the field of view of the head-wearable apparatus based on the eye gaze information;
processing, by a generative machine learning model, the contextual information and at least one image of the field of view of the head-wearable apparatus to generate an output; and
presenting on a display of the head-wearable apparatus the output generated by the generative machine learning model.

20. A non-transitory computer-readable storage medium storing instructions that, when executed by at least one processor, cause the at least one processor to perform operations comprising:
accessing eye gaze information associated with a field of view of a head-wearable apparatus;
generating contextual information associated with the field of view of the head-wearable apparatus based on the eye gaze information;
processing, by a generative machine learning model, the contextual information and at least one image of the field of view of the head-wearable apparatus to generate an output; and
presenting on a display of the head-wearable apparatus the output generated by the generative machine learning model.
